(19) United States
(12) Patent Application Publication
(10) Pub. No.: US 2017/0283685 A1
(43) Pub. Date: Oct. 5, 2017

(54) SPECIFIC INHIBITORS OF (PER)CHLORATE RESPIRATION AS A MEANS TO ENHANCE THE EFFECTIVENESS OF (PER)CHLORATE AS A SOURING CONTROL MECHANISM IN OIL RESERVOIRS

(71) Applicant: The Regents of the University of California, Oakland, CA (US)

(72) Inventor: John D. COATES, Walnut Creek, CA (US)

(73) Assignee: The Regents of the University of California, Oakland, CA (US)

(21) Appl. No.: 15/510,169

(22) PCT Filed: Sep. 11, 2015
(86) PCT No.: PCT/US15/49752

§ 371 Date: Mar. 9, 2017

Related U.S. Application Data
(60) Provisional application No. 62/050,032, filed on Sep. 12, 2014.

(51) Int. Cl. C09K 8/528; C09K 8/54; C09K 8/532

(52) U.S. Cl. CPC C09K 8/528; C09K 8/532; C09K 8/54; C09K 2208/20; C09K 2208/32

(57) ABSTRACT

The present disclosure relates generally to methods of controlling souring in systems, and more specifically to methods of using chlorine oxyanions and inhibitors of (per)chlorate respiration to control souring in a system.

### CROSS-REFERENCE TO RELATED APPLICATION

This application claims the benefit of U.S. Provisional patent application Ser. No. 62/050,032, filed Sep. 12, 2014, which is hereby incorporated by reference, in its entirety.

### FIELD

The present disclosure relates generally to methods of controlling souring in systems, and more specifically to methods of using chlorine oxyanions and inhibitors of (per)chlorate respiration to control souring in a system.

### BACKGROUND

Although non-traditional energy sources such as bioethanol, solar, and wind will increase over the coming decades, it is predicted that these will account for less than 10% of total demand by 2030 (U.S. Department of Energy: www.eia.doe.gov/oiaf/ieo/index.html). As such, global reliance on fossil energy and oil recovery will likely continue to dominate in the near future. An important aspect of oil recovery is control of reservoir bio-souring, which is the result of in situ hydrogen sulfide (H₂S) biogeneration, typically after initiation of secondary recovery processes involving injection of sulfate-rich seawater (Gieg et al., 2011; Youssef et al., 2009).

As the primary cause of industrial gas inhalation deaths in the US (https://www.osha.gov/SLTC/hydrogensulfide/hazards.html), the generation of H₂S by sulfate reducing microorganisms (SRM) poses significant health and environmental risks, and results in a variety of oil recovery problems including contamination of crude oil, metal corrosion, and precipitation of metal sulfides that plug pumping wells (Fuller et al., 2000; Vance et al., 2005). Multiple representatives within the domains Archaea and Bacteria have been identified as SRM contributing to souring in oil reservoirs. As such, targeting of specific species, genera, or even phyla for inhibition is of limited value. Because of this, efforts have focused on mechanisms by which the dissimilatory sulfate-reducing metabolism can be inhibited.

Intensive research has centered on thermodynamic inhibition of SRM by the addition of nitrate to the injection waters (Gieg et al., 2011; Youssef et al., 2009; Hubert et al., 2010; Voordouw et al., 2009). Thermodynamic considerations indicate that microbial nitrate reduction is energetically more favorable than sulfate reduction and should therefore occur first (Lovley et al., 1995). For example, the Gibbs free energy for the anaerobic degradation of toluene coupled to nitrate reduction (ΔG^{o}′=−3,529 kJmol⁻¹ toluene) is significantly higher than that coupled to sulfate reduction (ΔG^{o}′=−179 kJmol⁻¹ toluene)(Rabus et al., 1998). While bio-competitive exclusion may operate in some systems, the favorable thermodynamics of nitrate reduction does not exclude the prospect that sulfate reduction can still occur if the electron donor is saturating (Lovley et al., 1988), as is the case in an oilfield. The electron acceptor being consumed at any specific location is controlled by the respective concentrations of the electron donor and individual electron acceptors (Coates et al., 1996; Coates et al., 2001; Lovley et al., 1995; Christensen et al., 2000). Thus, as nitrate depletes in the near-well environment, or in microenvironments within the reservoir matrix, sulfate reduction can still be active deeper in the reservoir (Voordouw et al., 2009; Callbeck et al., 2011). While nitrite, a transient intermediate of nitrate reduction, can have a significant inhibitory effect on SRM (Callbeck et al., 2013), it is also chemically and biologically labile and has a limited half-life in a reduced reservoir matrix. Furthermore, the Nrf nitrite reductase is widely distributed amongst the known SRM, and has been demonstrated to provide an intrinsic defense mechanism against nitrite toxicity (Greene et al., 2003). Finally, nitrate also enriches for lithoautotrophic sulfur oxidizing nitrate reducing bacteria that oxidize sulfide to sulfate and mask the activity of active SRM (Gevertz et al., 2000). As such, in order to ensure inhibition of active sulfate reduction, it is imperative to maintain a nitrate concentration in injection fluids high enough to prevent nitrate depletion during its residence in the formation and biogenesis of large quantities of nitrite (Callbeck et al., 2013). Under these conditions, nitrate addition can successfully impede SRM activity, although not necessarily completely attenuate it (Callbeck et al., 2013; Sunde et al., 2005). However, this requires the addition of saturating amounts of nitrate, which is not always financially feasible or logistically possible.

Thus, there exists a need to develop an economic and efficient method for controlling souring in systems, such as oil reservoirs.

### BRIEF SUMMARY

In one aspect, the present disclosure provides a method for controlling souring, the method including: a) providing a system including one or more sulfate-reducing microorganisms and one or more (per)chlorate-reducing bacteria; b) contacting the system with a composition including one or more chlorine oxyanions, or one or more precursor compounds which yield one or more chlorine oxyanions, where the chlorine oxyanions are present in the system at a concentration sufficient to inhibit souring in the system; and c) contacting the system with a composition including an inhibitor of (per)chlorate respiration, where the inhibitor of (per)chlorate respiration is present in the system at a concentration sufficient to inhibit (per)chlorate respiration by the one or more (per)chlorate-reducing bacteria, where (per)chlorate consumption is reduced and souring is inhibited in the system. In some embodiments, the system is an oil reservoir. In some embodiments that may be combined with any of the preceding embodiments, the one or more (per)chlorate-reducing bacteria are selected from the group including Ideonella; Dechloromarinus; Dechloromarinus strain NSS; Dechloromonas; Dechloromonas strain FL2, FL8, FL9, CKB, CL, NM, MLC33, JM, HZ, CL24plus, CL24, CC0, RCB, SIUL, and MissR; Dechloromonas aromaticae; Dechloromonas hortensis; Magnetospirillum; Magnetospirillum strain SN1, WD, DB, and VDY; Azospirillum; Azospirillum strain TTI; Azospira; Azospira strain AH, Iso1, Iso2, SDGM, PDX, KJ, GR-1, and perclace; Azospira suillum strain PS; Acrobacter; Acrobacter strain CAB; Dechlorobacter; Dechlorobacter hydrogenophilus strain LT-1; Propionivibrio; Propionivibrio strain MP; Wolinella; Wolinella succinogenes strain HAP-1; Moorella; Moorella perchloratireducens, Moorella thermoacetica; Sporomusa; Sporomusa strain An4; Ferroglobus placidus; Desulfosporosinus meridiei; Desulfitobacterium dehalogenans; D. dechloroeliminans; Carboxydothermus hydrogenoformans; Proteus; Proteus mirabilis; Escherichia; Shewanella; Shewanella alga; Shewanella alga strain ACDC; Shewanella oneidensis strain MR1; Sedimenticola; Sedimenticola selenatireducens AK40H1; Sedimenticola selenatireducens CUZ; Rhodobacter; Rhodobacter capsulatus; Rhodobacter sphaeroides; Alicycliphilus; Alicycliphilus denitroficans; Pseudomonas strain PK, CFPBD, PDA, and PDB; Pseudomonas chloritidismutans; and Archaeglobus; Archaeglobus fulgidus. In some embodiments that may be combined with any of the preceding embodiments, the one or more chlorine oxyanions are selected from the group including hypochlorite, chlorine dioxide, chlorite, chlorate, perchlorate, and mixtures thereof. In some embodiments, the one or more chlorine oxyanions are perchlorate. In some embodiments that may be combined with any of the preceding embodiments, the method further includes adding nitrite and/or nitrate at a concentration sufficient to inhibit souring in the system. In some embodiments, the nitrite and/or nitrate is added to the system prior to adding the composition including one or more chlorine oxyanions to the system, or the one or more compounds which yield the one or more chlorine oxyanions. In some embodiments, nitrite is added in an amount sufficient to yield a chlorine oxyanion to nitrite ratio of at least 100:1 in the system. In some embodiments that may be combined with any of the preceding embodiments, the method further includes a step of removing elemental sulfur produced by the one or more (per)chlorate-reducing bacteria from the system. In some embodiments that may be combined with any of the preceding embodiments, the inhibitor of (per)chlorate respiration is a structural analog of (per)chlorate. In some embodiments, the inhibitor of (per)chlorate respiration is selected from the group including bromate, periodate, and iodate. In some embodiments that may be combined with any of the preceding embodiments, the concentration of the inhibitor of (per)chlorate respiration in the system is in the range of about 0.05 mM to about 10 mM. In some embodiments that may be combined with any of the preceding embodiments, souring in the system is inhibited by about 50% or more as compared to a corresponding system not contacted with one or more chlorine oxyanions and one or more inhibitors of (per)chlorate respiration. In some embodiments, souring is assayed by measuring parameters selected from the group including sulfate respiration, hydrogen sulfide production, fluid contamination, metal corrosion, and clogging of the system. In some embodiments that may be combined with any of the preceding embodiments, the one or more (per)chlorate-reducing bacteria include one or more recombinant nucleic acids selected from the group consisting of a nucleic acid that encodes nar (Af_0174-0176); a nucleic acid that encodes pcrA (Daro_2584), a nucleic acid that encodes pcrB (Daro_2583), a nucleic acid that encodes pcrC (Daro_2582), a nucleic acid that encodes pcrD (Daro_2581), a nucleic acid that encodes cld (Daro_2580), a nucleic acid that encodes moaA (Daro_2577), a nucleic acid that encodes pcrQ (Daro_2579), a nucleic acid that encodes pcrO (Daro_2578), a nucleic acid that encodes pcrS (Daro_2586), a nucleic acid that encodes pcrR (Daro_2585), a nucleic acid that encodes pcrP (Daro_2587), a nucleic acid that encodes S (Daro_2590), a nucleic acid that encodes AS (Daro_2589), a nucleic acid that encodes OR1 (Daro_2591), a nucleic acid that encodes OR2 (Daro_2592), and a nucleic acid that encodes OR3 (Daro_2593). In some embodiments that may be combined with any of the preceding embodiments, the one or more (per)chlorate-reducing bacteria include a cryptic (per)chlorate reduction pathway. In some embodiments, the one or more (per)chlorate-reducing bacteria are selected from organisms containing Nar-type periplasmic DMSO II oxidoreductase enzymes (pNar).

In another aspect, the present disclosure provides a method for controlling souring, the method including: a) providing a system including one or more sulfate-reducing microorganisms; b) contacting the system with one or more compounds selected from the group including bromate, iodate, and periodate, where the one or more compounds are present in the system at a concentration sufficient to inhibit souring in the system. In some embodiments, the system further includes one or more (per)chlorate-reducing bacteria. In some embodiments, the method further includes contacting the system with a composition including one or more chlorine oxyanions, or one or more precursor compounds which yield one or more chlorine oxyanions. In some embodiments, the one or more chlorine oxyanions are selected from the group including hypochlorite, chlorine dioxide, chlorite, chlorate, perchlorate, and mixtures thereof. In some embodiments, the one or more chlorine oxyanions are perchlorate. In some embodiments that may be combined with any of the preceding embodiments, the method further includes adding nitrite and/or nitrate at a concentration sufficient to inhibit souring in the system. In some embodiments, the nitrite and/or nitrate is added to the system prior to adding the composition including one or more chlorine oxyanions to the system, or the one or more compounds which yield the one or more chlorine oxyanions. In some embodiments, nitrite is added in an amount sufficient to yield a chlorine oxyanion to nitrite ratio of at least 100:1 in the system. In some embodiments that may be combined with any of the preceding embodiments, the method further includes a step of removing elemental sulfur produced by the one or more (per)chlorate-reducing bacteria from the system. In some embodiments that may be combined with any of the preceding embodiments, the concentration of one or more of bromate, iodate, and/or periodate in the system is in the range of about 0.05 mM to about 10 mM. In some embodiments that may be combined with any of the preceding embodiments, souring in the system is inhibited by about 50% or more as compared to a corresponding system not contacted with one or more of bromate, iodate, and/or periodate. In some embodiments, souring is assayed by measuring parameters selected from the group including sulfate respiration, hydrogen sulfide production, fluid contamination, metal corrosion, and clogging of the system. In some embodiments, the system is an engineered system.

In another aspect, the present disclosure provides a crude oil product produced by the method of any one of the preceding embodiments.

### DESCRIPTION OF THE FIGURES

FIG. 1A is a schematic showing how SRM acting on a sulfate (SO₄²⁻) substrate produces hydrogen sulfide (H₂S) and how this H₂S production can be inhibited by perchlorate (ClO₄⁻). FIG. 1B is a schematic of DPRB-mediated coupling of the oxidation of H₂S to elemental sulfur (S) and the reduction of ClO₄⁻ to chloride (Cl⁻). DPRB may also couple the oxidation of H₂S to elemental sulfur (S) and the reduction of chlorate (ClO₃⁻) to chloride (Cl⁻). FIG. 1C is a schematic of the combination of SRM-mediated production of hydrogen sulfide in a system with the DPRB-mediated oxidation of this hydrogen sulfide to produce elemental sulfur. FIG. 1D is a schematic of the combined metabolisms in a system outlined in FIG. 1C, but with the addition of a (per)chlorate respiration inhibitor.

FIG. 2 illustrates a model of an exemplary (per)chlorate reduction pathway in dissimilatory (per)chlorate-reducing bacteria (DPRB).

FIG. 3A-FIG. 3B illustrates a dose-response curve for bromate, iodate, and periodate inhibition of growth of (per)chlorate- or nitrate-reducing Azospira suillum PS. FIG. 3A illustrates the dose-response curve for bromate, iodate, and periodate inhibition of growth of Azospira suillum PS under (per)chlorate reducing conditions. “(Per)chlorate reducing cells” were incubated with either bromate, iodate, or periodate in the presence of perchlorate. FIG. 3B illustrates the dose-response curve for bromate, iodate, and periodate inhibition of growth of Azospira suillum PS under nitrate reducing conditions. “Nitrate reducing cells” were incubated with either bromate, iodate, or periodate in the presence of nitrate.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

The present disclosure relates generally to methods of controlling souring in systems, and more specifically to methods of using chlorine oxyanions and inhibitors of (per)chlorate respiration to control souring in a system.

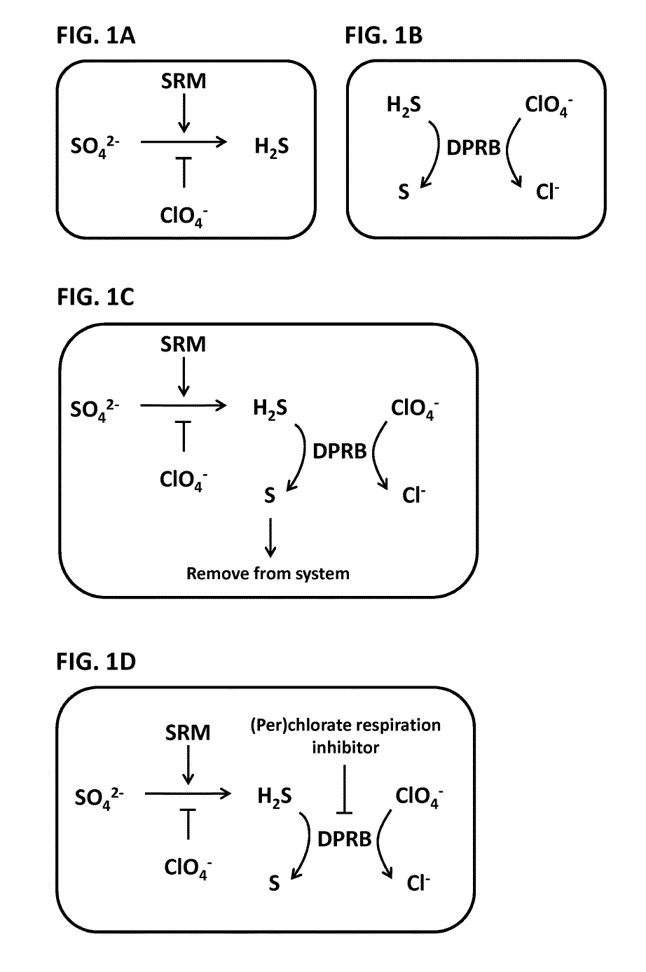

Certain methods of the present disclosure involve systems containing one or more sulfate-reducing microorganisms (SRM) and one or more (per)chlorate-reducing bacteria (DPRB). Schematics of various metabolic activities in systems related to the methods of the present disclosure are presented in FIG. 1A through FIG. 1D. As described above, FIG. 1A shows that sulfate-reducing microorganisms (SRM) are able to produce hydrogen sulfide from sulfate, but that the presence of (per)chlorate ions (ClO₄⁻ and ClO₃⁻) can inhibit the formation of H₂S by inhibiting the sulfate-reducing activity of SRM. Without wishing to be bound by theory, it is believed that the inhibitory effect of the (per)chlorate ions is due to inhibition of one or a combination of sulfate uptake by the SRM, inhibition of the ATP-sulfurylase enzyme in SRM, or inhibition of the APS-reductase enzyme in SRM, which are all required for efficient reduction of sulfate to hydrogen sulfide by SRM.

The present disclosure also relates to the metabolic activity of dissimilatory (per)chlorate reducing bacteria (DPRB). FIG. 1B shows that DPRB can oxidize H₂S to elemental sulfur, and that this oxidation is coupled with reduction of ClO₄⁻ or ClO₃⁻ to chloride ions (Cl⁻).

Applicants previously developed a strategy to biologically control biogenic H₂S generation based on the introduction of perchlorate (ClO₄⁻) or chlorate (ClO₃⁻), collectively referred to as (per)chlorate, into injection waters and the stimulation of the activity of dissimilatory (per)chlorate reducing bacteria (DPRB) in oil reservoirs (See WO/2012/166964). This approach is summarized in FIG. 1C. Without wishing to be bound by theory, it is believed that not only can (per)chlorate ions inhibit the formation of H₂S by inhibiting the sulfate-reducing activity of SRM, but the presence of (per)chlorate can also stimulate (per)chlorate respiration in DPRB, which involves the oxidation of H₂S to elemental sulfur coupled with reduction of (per)chlorate to chloride ions (Cl⁻). The produced sulfur can then be removed from the system.

The advantage of this previously developed approach over other methods is that in addition to thermodynamic preference (E^{o}′=+797 mV and +792 mV for the biological couple of ClO₄⁻/Cl⁻ and ClO₃⁻/Cl⁻ respectively) relative to sulfate reduction (E^{o}′=−217 mV), (per)chlorate is also directly and specifically inhibitory to microbial sulfate reduction (Postgate, 1952; Baeuerle et al., 1986). This is in contrast to nitrate inhibition of microbial sulfate reduction, which is primarily due to the production of the toxic transient intermediate nitrite (He et al., 2010). An additional aspect of souring treatment by (per)chlorate is based on the fact that while these compounds are kinetically stable in the presence of sulfide (Gregoire et al., 2014), all DPRB tested to date innately oxidize H₂S rapidly (Bruce et al., 1999; Coates et al., 2004; Coates et al., 1999), preferentially utilizing it over labile organic electron donors and producing benign elemental sulfur as the sole end product of the metabolism (Gregoire et al., 2014).

As such, two phases of a (per)chlorate and DPRB-based treatment of a system that is undergoing or has the potential to undergo souring can be delineated: (i) inhibition of SRM-mediated sulfate reduction by (per)chlorate and thus inhibition of sulfide production by SRM; and (ii) re-oxidation of any sulfide produced by SRM to sulfur, this oxidation being mediated by (per)chlorate-reducing bacteria (DPRB)(See FIG. 1C). However, once sulfide oxidation is sufficiently complete and removed from the system, without wishing to be bound by theory, it is believed that continued activity of DPRB in the system is unwarranted and costly, as the DPRB result in the consumption of the SRM inhibitor ((per)chlorate) at the expense of organics (hydrocarbons) in the reservoir and potentially increase the possibility of undesirable biomass plugging.

The present disclosure is based, at least in part, on Applicant's discovery that the compounds bromate, periodate, and iodate, which are all halogenated analogs of (per)chlorate, are specific inhibitors of (per)chlorate respiration. The present disclosure thus details a process for controlling the activity of DPRB in an environment by contacting the environment with specific inhibitors of (per)chlorate respiration, such as bromate, periodate, and iodate (See FIG. 1D). Inhibitors of (per)chlorate respiration may be added to a system containing both sulfate-reducing microorganisms (SRM) and dissimilatory (per)chlorate reducing bacteria (DPRB) after such a system has been provided with chlorine oxyanions and DPRB allowed to oxidize sulfides to elemental sulfur. By providing these inhibitors in waters associated with active (per)chlorate respiration by DPRB, (per)chlorate consumption by DPRB will be inhibited. Without wishing to be bound by theory, it is thought that by such inhibition of (per)chlorate respiration, (per)chlorate oxyanions will not be consumed by DPRB and thus will retain their activity against the souring-promoting activity of sulfate reducing microorganisms and continue to inhibit souring activity in the system. An additional aspect of this approach is that many of the (per)chlorate respiration inhibitors described above, such as bromate, are also effective inhibitors of SRM and thus may enhance the effectiveness of (per)chlorate addition in controlling souring, or these (per)chlorate respiration inhibitors may act to control souring independently.

Accordingly, Applicants disclose herein methods and compositions for controlling souring in a system. The methods of the present disclosure may involve systems having one or more sulfate-reducing microorganisms and one or more (per)chlorate-reducing microorganisms. Certain methods involve introducing chlorine oxyanions, such as perchlorate, into the system to inhibit sulfate-reducing microorganisms and souring in the system, and then introducing an inhibitor of (per)chlorate respiration to inhibit DPRB consumption of the (per)chlorate chlorine oxyanions, which act as souring inhibitors, to further control souring. Certain methods involve introducing an inhibitor of (per)chlorate respiration, such as bromate, iodate, or periodate, into the system to inhibit sulfate-reducing microorganisms and souring in the system.

### Types of Systems

The methods of the present disclosure relate to the use of chemical and/or physical approaches to controlling souring in a system such as, for example, an engineered system. The disclosed methods may be used to treat various systems where sulfate-reducing microorganisms (SRM) are causing, have caused, or have the potential to cause generation of sulfide-containing compounds, such as hydrogen sulfide (H₂S). Examples of systems include aqueous environments such as pits or water-containment ponds and various marine environments. Additionally, the disclosed methods can be used to treat various systems containing sulfide-containing compounds such as H₂S. Examples include oil refineries, CO₂ storage wells, chemical plants, desalination plants, and wastewater treatment plants.

Examples of engineered systems in the present disclosure include those systems in the field of oil recovery. The injection of water is a commonplace practice to increase oil production beyond primary production yields by maintaining reservoir pressure and sweeping oil from the injection wells towards the production wells. If seawater is used as the water source, oil souring often occurs, as the seawater contains SRM and conditions conducive to the activity of SRM are created within the reservoir matrix. SRM are found in seawater, as they are indigenous to all marine environments.

Further examples of suitable systems include oil and gas reservoirs, oil-water separators, wellheads, oil or gas storage tanks, oil pipelines, a gas pipeline or a gas supply line, natural gas reservoir, cooling water tower, coal slurry pipelines, and other tanks or equipment that may contain SRM. In some embodiments, the system is the near-well environment of the oil or gas reservoir. In other embodiments, the system is the environment deeper in the reservoir. In some embodiments, the system is the entire oil or gas reservoir.

Another exemplary system includes CO₂ storage wells. Sulfide and oxygen present in the storage wells can stimulate microbial H₂SO₄ production in the wells in addition to the sulfidic sour gas. This can lead to extensive metal corrosion and concrete corrosion of the wells.

In some embodiments, the system is a processing plant that utilizes sulfide-containing compounds or compounds that produce sulfides as a byproduct. Examples of such compounds include, oil, gas, and hydrocarbons. Examples of processing plants include refineries, gas-liquid separators, and chemical plants.

In some embodiments, the system is waste waters bearing sulfur or its oxyanions from various industries. In some embodiments, the system is wastewater effluent from a pulp or paper mill. In other embodiments, the system is wastewater effluent from a tannery. In other embodiments, the system is wastewater effluent from a textile mill. Additional suitable systems for use in the methods of the present disclosure will be readily apparent to one of skill in the art.

### Sulfate-Reducing Microorganisms

Certain aspects of the present disclosure relate to inhibiting sulfate-reduction by (dissimilatory) sulfate-reducing microorganisms (SRM). As used herein, the terms “(dissimilatory) sulfate-reducing microorganisms (SRM),” “dissimilatory sulfate-reducing microorganisms,” “sulfate-reducing microorganisms,” and “SRM,” are used interchangeably and refer to microorganisms that are capable of reducing sulfur or its oxyanions to sulfide ions. The accumulation of sulfide-containing compounds, such as hydrogen sulfide (H₂S) in systems contributes to the souring of the system. Accordingly, SRM are generally considered to promote souring in systems.

Dissimilatory sulfate-reducing microorganisms (SRM) of the present disclosure may reduce sulfate in large amounts to obtain energy and expel the resulting sulfide as waste. Additionally, SRM of the present disclosure may utilize sulfate as the terminal electron acceptor of their electron transport chain. Typically, SRM are capable of reducing other oxidized inorganic sulfur compounds, including, for example, sulfite, thiosulfate, and elemental sulfur, which may be reduced to sulfide as hydrogen sulfide.

Dissimilatory sulfate-reducing microorganisms (SRM) of the present disclosure are commonly found in sulfate rich environments, such as seawater, sediment, and water rich in decaying organic material. Thus, SRM are common in typical floodwater utilized in oil reservoirs, and are the major cause of sulfide production in oil reservoir souring (Vance and Thrasher, Petroleum Microbiology, eds B. Ollivier & M. Magot, ASM Press, 2005).

Dissimilatory sulfate-reducing microorganisms (SRM) of the present disclosure include, for example, organisms from both the Archaea and Bacteria domains including hyperthermophiles, thermophiles, mesophiles, and psychrophiles. Examples of SRM also include, for example, thermophilic Archaea such as Archaeglobus species or members of the δ sub-group of Proteobacteria, such as Desulfobacterales, Desulfovibrionales, and Syntrophobacterales. In some embodiments, the SRM are from the species Desulfovibrio and Desulfuromonas. In some embodiments, the SRM is Desulfovibrio alaskensis G20. Other sulfate-reducing microorganisms (SRM) will be readily apparent to one of skill in the art.

Sulfate-reducing microorganisms of the present disclosure may be present in a system as part of a souring-promoting microbial community. Souring-promoting microbial communities include those microbial communities that contain at least one or more microorganisms that are sulfate-reducing microorganisms (SRM) or that are otherwise capable of producing sulfide-containing compounds.

### (Dissimilatory) (Per)Chlorate-Reducing Bacteria (DPRB)

Certain aspects of the present disclosure relate to (dissimilatory) (per)chlorate-reducing bacteria (DPRB), and their use in decreasing the amount of one or more sulfide-containing compounds and inhibiting souring in a system. As used herein, the terms “(dissimilatory) (per)chlorate-reducing bacteria (DPRB),” “(dissimilatory) (per)chlorate-reducing bacteria,” “dissimilatory (per)chlorate-reducing bacteria,” and “DPRB” may be used interchangeably and refer to microorganisms that have perchlorate- and/or chlorate-reducing activity that allow the microorganisms to metabolize chlorine oxyanions into innocuous chloride ions. Advantageously, the (per)chlorate-reducing activity of DPRB of the present disclosure can be coupled to sulfide oxidation to reduce and/or eliminate SRM-produced sulfide contaminations in systems of the present disclosure, such as oil reservoirs.

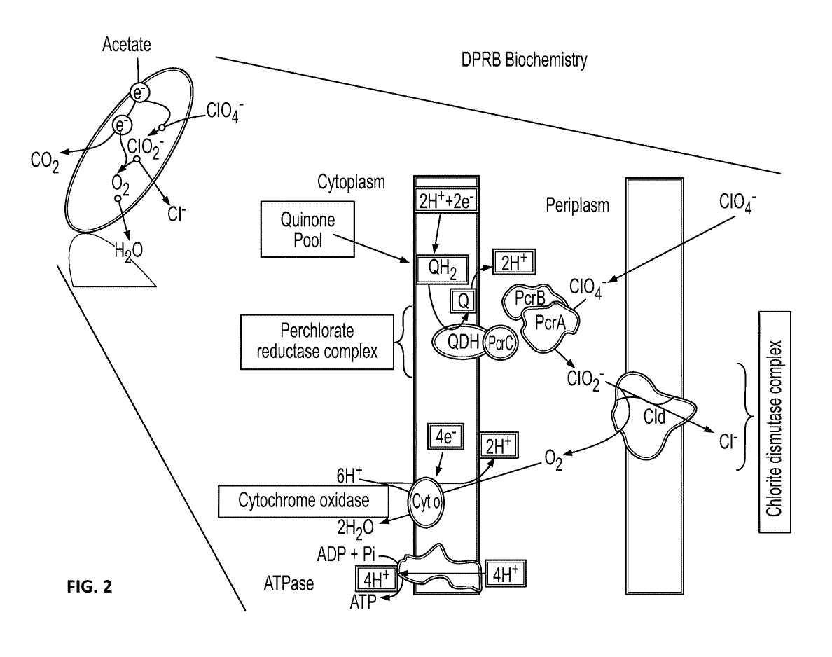

Dissimilatory (per)chlorate-reducing bacteria (DPRB) of the present disclosure contain a (per)chlorate reduction pathway. Mechanisms of (per)chlorate reduction in organisms are known in the art. A model depicting an exemplary (per)chlorate reduction pathway present in a DPRB of the present disclosure is presented in FIG. 2. In particular, DPRB of the present disclosure may express at least one perchlorate reductase and may express at least one chlorite dismutase. Various organisms containing various mechanisms of (per)chlorate reduction may be used in the methods of the present disclosure.

Additional (per)chlorate reduction pathways are known in the art. For example, Liebensteiner et al. (2013) describe a cryptic (per)chlorate reduction pathway in Archaeglobus. It is generally thought that bacteria that use (per)chlorate as an electron acceptor utilize a cycle in which perchlorate (ClO₄⁻) is reduced to chlorate (ClO₃⁻) by a perchlorate reductase, chlorate is then reduced to chlorite (ClO₂⁻) by a chlorate reductase, and chlorite is further reduced to chloride and oxygen (Cl⁻+O₂) by a chlorite dismutase. However, Liebensteiner et al. have demonstrated that A. fulgidus, an Archaebacterium that is able to use (per)chlorate as an electron acceptor during growth, contains a genome apparently devoid of any genes predicted to code for a chlorite dismutase, and cell extracts from this species lack chlorite dismutase activity. Despite this, chlorite does not accumulate during reduction of (per)chlorate in this microbe. Since A. fulgidus is known to reduce sulfate to sulfide (SO₄²⁻→S²⁻), and sulfide can react with chlorite to form sulfate and chloride (2ClO₂⁻+S²⁻→SO₄²⁻+2Cl⁻), without wishing to be bound by theory, it is thought that A. fulgidus uses a biotic process to metabolize (per)chlorate to chlorite, and an abiotic process to further metabolize chlorite to chloride by coupling (per)chlorate reduction to sulfur metabolism. To summarize, without wishing to be bound by theory, it is thought that the (per)chlorate reduction pathway of A. fulgidus uses a) a biotic process, catalyzed by enzymatic activity (ClO₄⁻→ClO₃⁻→ClO₂⁻) and b) an abiotic process, catalyzed by sulfide (ClO₂⁻→Cl⁻).

Additionally, DPRB of the present disclosure may express one or more of the following gene clusters in total or in part: pcrABCD (encoding components/accessory genes of perchlorate reductase), crABC (encoding chlorate reductase subunits), cld (encoding chlorite dismutase), cbb3 (encoding cytochrome oxidase), moaA (encoding molybdopterin biosynthesis protein A), QDH (encoding a membrane-associated tetraheme c-type cytochrome with quinol dehydrogenase activity), DHC (encoding a diheme c-type cytochrome), HK (encoding a histidine kinase), RR (encoding a response regulator), PAS (encoding a PAS domain sensor), S (encoding a sigma factor), AS (encoding an anti-sigma factor), and OR (encoding an oxidoreductase component). Further, DPRB of the present disclosure may also contain one or more genes encoding assimilatory nitrate reductases or dissimilatory nitrate reductases, or promiscuous members of the DMSO protein family of reductases including pNar type II DMSO reductases.

Moreover, DPRB of the present disclosure may also exhibit a broad range of metabolic capabilities including, for example, the oxidation of hydrogen, simple organic acids and alcohols, aliphatic and aromatic hydrocarbons, hexoses, reduced humic substances, both soluble and insoluble ferrous iron, electrically charged cathodes, and both soluble sulfide (e.g., HS⁻) and insoluble sulfide (e.g., FeS). In some embodiments, the DPRB are facultatively anaerobic or micro-aerophilic with molecular oxygen being produced as a transient intermediate of the microbial reduction of (per)chlorate. Additionally, and without wishing to be bound by theory, it is believed that molybdenum is generally required by DPRB. However, it is unlikely that molybdenum is present in limiting concentrations in the natural environment. Accordingly, in some embodiments, the DPRB may be dependent on molybdenum for their metabolism.

Dissimilatory (per)chlorate-reducing bacteria (DPRB) of the present disclosure may be endogenous to any of the systems of the present disclosure, or may be added exogenously to any system of the present disclosure. Accordingly, in certain embodiments of the methods of the present disclosure, the DPRB are endogenous to the system. In other embodiments, methods of the present disclosure include a step of adding exogenous DPRB to the system. For example, exogenous DPRB may be added to system via injection of either active whole cells or starved ultramicrobacteria. In some embodiments, the exogenous DPRB are added at cell densities suitable to oxidize SRM-produced sulfide compounds into elemental sulfur.

Isolated DPRB

Various DPRB known in the art may be utilized in the compositions, systems, and methods of the present disclosure. Moreover, additional DPRB may be isolated from a broad diversity of environments including, for example, oil reservoir fluids and matrices, both pristine and contaminated soils, and sediments. Examples of sediments include those from freshwater lakes, lagoons, farm swine lagoons, swamp lands, rivers, mine drainage, salt-water lakes, bays, seas, and oceans.

Methods for isolating DPRB are well known in the art, and include, for example, those disclosed herein, and those disclosed in Coates et al., Appl Environ Microbiol. 1999 December; 65(12):5234-41; Bruce et al., Environ Microbiol. 1999 August; 1(4):319-29; Achenbach et al., Int J Syst Evol Microbiol. 2001 March; 51 (Pt 2):527-33; O'Connor and Coates, Appl Environ Microbiol. 2002 June; 68(6):3108-13; Bender et al., Appl Environ Microbiol. 2004 September; 70(9):5651-8; Thrash et al., Appl Environ Microbiol. 2010 July; 76(14):4730-7; and Melnyk et al., Appl Environ Microbiol. 2011 October; 77(20):7401-4. For example, cultured-based methods, such as serial dilutions of environmental samples may be used; immunoprobe-based methods utilizing perchlorate reductase-specific antibodies and/or chlorite dismutase-specific antibodies may be used; and genetic probe-based methods utilizing probes that target perchlorate reductase and/or chlorite dismutase genes may be used. For example, the above methods may be used to target and/or identify Nar-type periplasmic DMSO II oxidoreductase enzymes (pNar).

DPRB enrichment cultures may be established by transferring a sample from a freshly collected oil reservoir material, soil, or sediment into an anoxic medium under, for example, an N₂—CO₂ gas stream. An appropriate electron donor, such as acetate, and electron acceptor, such as (per)chlorate, are included in the medium. As only microorganisms capable of reducing (per)chlorate will be able to grow in such medium, positive enrichment cultures can be identified on the basis of an increase in growth and consumption of (per)chlorate. Positive enrichment cultures can then be serially diluted to isolate individual strains.

Examples of DPRB having chlorate-reducing activity include, for example, Ideonella, Dechloromarinus, Shewanella, and Pseudomonas.

Examples of DPRB having perchlorate- and chlorate-reducing activity include, for example, Archaeglobus; Dechloromarinus; Dechloromarinus strain NSS; Dechloromonas; Dechloromonas strain FL2, FL8, FL9, CKB, CL, NM, MLC33, JM, HZ, CL24plus, CL24, CC0, RCB, SIUL, or MissR; Dechloromonas aromaticae; Dechloromonas hortensis; Magnetospirillum; Magnetospirillum strain SN1, WD, DB, or VDY; Azospirillum; Azospirillum strain TTI; Azospira; Azospira strain AH, Iso1, Iso2, SDGM, PDX, KJ, GR-1, or perclace; Azospira suillum strain PS; Dechlorobacter; Dechlorobacter hydrogenophilus strain LT-1; Propionivibrio; Propionivibrio strain MP; Wolinella; Wolinella succinogenes strain HAP-1; Moorella; Moorella perchloratireducens; Sporomusa; Sporomusa strain An4; Proteus; Proteus mirabilis; Escherichia; Shewanella; Shewanella alga; Shewanella alga strain ACDC; Shewanella oneidensis strain MR1; Rhodobacter; Rhodobacter capsulatus; Rhodobacter sphaeroides; Alicycliphilus; Alicycliphilus denitroficans; Pseudomonas strain PK, CFPBD, PDA, or PDB; and Pseudomonas chloritidismutans.

Examples of (per)chlorate-reducing bacteria include, for example, Ideonella; Dechloromarinus; Dechloromarinus strain NSS; Dechloromonas; Dechloromonas strain FL2, FL8, FL9, CKB, CL, NM, MLC33, JM, HZ, CL24plus, CL24, CC0, RCB, SIUL, and MissR; Dechloromonas aromaticae; Dechloromonas hortensis; Magnetospirillum; Magnetospirillum strain SN1, WD, DB, and VDY; Azospirillum; Azospirillum strain TTI; Azospira; Azospira strain AH, Iso1, Iso2, SDGM, PDX, KJ, GR-1, and perclace; Azospira suillum strain PS; Acrobacter; Acrobacter strain CAB; Dechlorobacter; Dechlorobacter hydrogenophilus strain LT-1; Propionivibrio; Propionivibrio strain MP; Wolinella; Wolinella succinogenes strain HAP-1; Moorella; Moorella perchloratireducens, Moorella thermoacetica; Sporomusa; Sporomusa strain An4; Ferroglobus placidus; Desulfosporosinus meridiei; Desulfitobacterium dehalogenans; D. dechloroeliminans; Carboxydothermus hydrogenoformans; Proteus; Proteus mirabilis; Escherichia; Shewanella; Shewanella alga; Shewanella alga strain ACDC; Shewanella oneidensis strain MR1; Sedimenticola; Sedimenticola selenatireducens AK40H1; Sedimenticola selenatireducens CUZ; Rhodobacter; Rhodobacter capsulatus; Rhodobacter sphaeroides; Alicycliphilus; Alicycliphilus denitroficans; Pseudomonas strain PK, CFPBD, PDA, and PDB; Pseudomonas chloritidismutans; and Archaeglobus; Archaeglobus fulgidus. One of skill in the art would readily appreciate these and other DPRB that may be used in the methods of the present disclosure.

Mutant and Variant DPRB

Dissimilatory (per)chlorate-reducing bacteria (DPRB) of the present disclosure also include mutants and variants of isolated DPRB strains (parental strains), which retain (per)chlorate-reducing activity. To obtain such mutants, the parental strain may be treated with a chemical such as N-methyl-N′-nitro-N-nitrosoguanidine, ethylmethanesulfone, or by irradiation using gamma, x-ray, or UV-irradiation, or by other means well known to those practiced in the art. Additionally, active enzymes isolated from DPRB and involved in (per)chlorate-reducing activity can be used for decreasing the amount of one or more sulfide-containing compounds in systems. Examples of enzymes include chlorate reductase subunits, perchlorate reductase subunits, chlorite dismutases, and cytochrome oxidases.

The term “mutant of a strain” as used herein refers to a variant of the parental strain. The parental strain is defined herein as the original isolated strain prior to mutagenesis. Mutagenesis may be accomplished by any method known in the art. For example, homologous recombination, chemical mutagenesis, radiation mutagenesis, and insertional mutagenesis may be used to generate mutants.

A “variant of a strain” can be identified as having a genome that hybridizes under conditions of high stringency to the genome of the parental strain. “Hybridization” refers to a reaction in which a genome reacts to form a complex with another genome that is stabilized via hydrogen bonding between the bases of the nucleotide residues that make up the genomes. The hydrogen bonding may occur by Watson-Crick base pairing, Hoogstein binding, or in any other sequence-specific manner. The complex may contain two strands forming a duplex structure, three or more strands forming a multi-stranded complex, a single self-hybridizing strand, or any combination of these. Hybridization reactions can be performed under conditions of different “stringency.” In general, a low stringency hybridization reaction is carried out at about 40° C. in 10×SSC or a solution of equivalent ionic strength/temperature. A moderate stringency hybridization is typically performed at about 50° C. in 6×SSC, and a high stringency hybridization reaction is generally performed at about 60° C. in 1×SSC.

In certain embodiments, DPRB added in the provided methods can be modified, e.g., by mutagenesis as described above, to stimulate (per)chlorate-reducing activity. For instance, these organisms may be modified to enhance expression of endogenous genes which may positively regulate the pathway involved in (per)chlorate-reduction. One way of achieving this enhancement is to provide additional exogenous copies of such positive regulator genes. Similarly, negative regulators of the pathway that are endogenous to the cell, may be removed.

Recombinant DPRB

Dissimilatory (per)chlorate-reducing bacteria (DPRB) of the present disclosure may further include microorganisms that do not naturally exhibit (per)chlorate-reducing activity, but where (per)chlorate-reducing activity has been introduced into the microorganism by various recombinant means known in the art. For example, the microorganism may be transformed with one or more of the pcrA, pcrB, pcrC, pcrD, pcrP, pcrQ, pcrR, pcrS, pcrO, cld, moaA, S, AS, OR1, OR2, OR3, Nar-type periplasmic DMSO II oxidoreductase genes, or homologs thereof. These genes are identified by the National Center for Biotechnology Information (NCBI) Gene ID numbers listed in Table 1.

TABLE 1

| Gene Name | NCBI Gene ID | Origin |
|---|---|---|
| pcrA | Daro_2584 | Dechloromonas aromatica strain RCB |
| pcrB | Daro_2583 | Dechloromonas aromatica strain RCB |
| pcrC | Daro_2582 | Dechloromonas aromatica strain RCB |
| pcrD | Daro_2581 | Dechloromonas aromatica strain RCB |
| pcrP | Daro_2587 | Dechloromonas aromatica strain RCB |
| pcrQ | Daro_2579 | Dechloromonas aromatica strain RCB |
| pcrR | Daro_2585 | Dechloromonas aromatica strain RCB |
| pcrS | Daro_2586 | Dechloromonas aromatica strain RCB |
| pcrO | Daro_2578 | Dechloromonas aromatica strain RCB |
| cld | Daro_2580 | Dechloromonas aromatica strain RCB |
| moaA | Daro_2577 | Dechloromonas aromatica strain RCB |
| S | Daro_2590 | Dechloromonas aromatica strain RCB |
| AS | Daro_2589 | Dechloromonas aromatica strain RCB |
| OR1 | Daro_2591 | Dechloromonas aromatica strain RCB |
| OR2 | Daro_2592 | Dechloromonas aromatica strain RCB |
| OR3 | Daro_2593 | Dechloromonas aromatica strain RCB |
| Nar | Af_0174-0176 | Archaeglobus fulgidus |

DPRB-Mediated Sulfide Oxidation

In certain embodiments, DPRB of the present disclosure can inhibit microbial sulfate-reduction based on thermodynamic preferences, e.g., by competing with SRM for electron donors such as lactate or hydrocarbons, which the DPRB then subsequently use to reduce chlorine oxyanions.

The DPRB employed in the methods of the present disclosure can utilize sulfide-containing compounds, such as H₂S, as electron donors to produce elemental sulfur.

In some embodiments, the disclosed methods further include a step of removing, from the system, the elemental sulfur produced by the DPRB. Methods of removing sulfur include, for example, filtration, centrifugation, and settlement ponds. Additionally, the elemental sulfur may also be used to alter the hydrology in an oil reservoir and improve sweep efficiency.

### Nucleic Acid Sequences Encoding DPRB Enzymes

Certain aspects of the present disclosure relate to DPRB genes encoding polypeptides involved in (per)chlorate-reduction. Accordingly, the present disclosure provides recombinant nucleic acid sequences encoding the DPRB genes nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), OR3 (Daro_2593), subsequences thereof, or homologous sequences thereof. The disclosure also provides for nucleic acid sequences having at least about 10%, 15%, 20%, 25%, 30%, 35%, 40%, 45%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 84%, 85%, 86%, 87%, 88%, 89%, 90%, 91%, 92%, 93%, 94%, 95%, 96%, 97%, 98%, 99%, or more, or complete (100%) sequence identity to the nucleic acid sequences encoding nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593), where the nucleic acid sequences encode polypeptides that retain (per)chlorate-reducing activities or functions.

The recombinant nucleic acids may be synthesized, isolated, or manipulated using standard molecular biology techniques such as those described in Sambrook, J. et al. 2000. Molecular Cloning: A Laboratory Manual (Third Edition). Techniques may include, for example, cloning, expression of cDNA libraries, and amplification of mRNA or genomic DNA.

In certain embodiments, the recombinant nucleic acids of the present disclosure may be optimized for improved activity or function. As used herein, “optimized” refers to the gene encoding a polypeptide having an altered biological activity or function, such as by the genetic alteration of the gene such that the encoded polypeptide has improved functional characteristics in relation to the wild-type polypeptide. An exemplary optimized gene may encode a polypeptide containing one or more alterations or mutations in its amino acid coding sequence (e.g., point mutations, deletions, addition of heterologous sequences) that facilitate improved expression and/or stability, allow regulation of polypeptide activity or function in relation to a desired substrate (e.g., inducible or repressible activity), modulate the localization of the polypeptide within a cell (e.g., intracellular localization, extracellular secretion), and/or affect the polypeptide's overall level of activity in relation to a desired substrate (e.g., reduce or increase enzymatic activity). In this manner, a polypeptide may be optimized with or without altering its wild-type amino acid sequence or original chemical structure. Optimized genes may be obtained, for example, by direct mutagenesis or by natural selection for a desired phenotype, according to techniques known in the art.

In certain embodiments, the DPRB can have optimized gene or polypeptide sequences involved in (per)chlorate-reduction, which include a nucleic acid coding sequence or amino acid sequence that is 50% to 99% identical to the nucleic acid or amino acid sequence of the reference (e.g., wild-type) gene or polypeptide. In certain embodiments, the optimized polypeptide may have about 1, 2, 3, 4, 5, 6, 7, 8, 9, 10, 20, 30, 40, 50, 100 (including all integers and decimal points in between, e.g., 1.2, 1.3, 1.4, 1.5, 5.5, 5.6, 5.7, 60, 70, etc.), or more times the biological activity or function of a reference polypeptide.

The recombinant nucleic acids of the present disclosure, or subsequences thereof, may be incorporated into a cloning vehicle containing an expression cassette or vector. The cloning vehicle can be a viral vector, a plasmid, a phage, a phagemid, a cosmid, a fosmid, a bacteriophage, or an artificial chromosome. The viral vector can comprise an adenovirus vector, a retroviral vector, or an adeno-associated viral vector. The cloning vehicle can contain a bacterial artificial chromosome (BAC), a plasmid, a bacteriophage P1-derived vector (PAC), a yeast artificial chromosome (YAC), or a mammalian artificial chromosome (MAC).

The nucleic acids may be operably linked to a promoter. The promoter may be, for example, a viral, bacterial, mammalian or plant promoter. The promoter may be, for example, a constitutive promoter, an inducible promoter, a tissue-specific promoter, or an environmentally regulated or a developmentally regulated promoter.

The present disclosure further provides transformed host cells including the recombinant nucleic acid having a nucleic acid sequence encoding nar (Af_0174-0176), alone or in combination with one or more of the recombinant nucleic acid having nucleic acid sequences encoding pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure further provides transformed host cells including the recombinant nucleic acid having a nucleic acid sequence encoding pcrA (Daro_2584); alone or in combination with one or more of the recombinant nucleic acid having nucleic acid sequences encoding nar (Af_0174-0176), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells including the recombinant nucleic acid having a nucleic acid sequence encoding pcrB (Daro_2583); alone or in combination with one or more of the recombinant nucleic acid having nucleic acid sequences encoding nar (Af_0174-0176), pcrA (Daro_2584), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells including the recombinant nucleic acid having a nucleic acid sequence encoding pcrC (Daro_2582); alone or in combination with one or more of the recombinant nucleic acid having nucleic acid sequences encoding nar (Af_0174-0176), pcrA (Daro_2584), pcrB (Daro_2583), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells including the recombinant nucleic acid having a nucleic acid sequence encoding pcrD (Daro_2581); alone or in combination with one or more of the recombinant nucleic acid having nucleic acid sequences encoding nar (Af_0174-0176), pcrA (Daro_2584), pcrB (Daro_2583), pcrC (Daro_2582), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells including the recombinant nucleic acid having a nucleic acid sequence encoding cld (Daro_2580); alone or in combination with one or more of the recombinant nucleic acid having nucleic acid sequences encoding nar (Af_0174-0176), pcrA (Daro_2584), pcrB (Daro_2583), pcrC (Daro_2582), pcrD (Daro_2581), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells including the recombinant nucleic acid having a nucleic acid sequence encoding moaA (Daro_2577); alone or in combination with one or more of the recombinant nucleic acid having nucleic acid sequences encoding nar (Af_0174-0176), pcrA (Daro_2584), pcrB (Daro_2583), pcrC (Daro_2582), pcrD (Daro_2581), cld (Daro_2580), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells including the recombinant nucleic acid having a nucleic acid sequence encoding pcrQ (Daro_2579); alone or in combination with one or more of the recombinant nucleic acid having nucleic acid sequences encoding nar (Af_0174-0176), pcrA (Daro_2584), pcrB (Daro_2583), pcrC (Daro_2582), pcrD (Daro_2581), cld (Daro_2580), moaA (Daro_2577), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells including the recombinant nucleic acid having a nucleic acid sequence encoding pcrO (Daro_2578); alone or in combination with one or more of the recombinant nucleic acid having nucleic acid sequences encoding nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells including the recombinant nucleic acid having a nucleic acid sequence encoding pcrS (Daro_2586); alone or in combination with one or more of the recombinant nucleic acid having nucleic acid sequences encoding nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells including the recombinant nucleic acid having a nucleic acid sequence encoding pcrR (Daro_2585); alone or in combination with one or more of the recombinant nucleic acid having nucleic acid sequences encoding nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrP (Daro_2587), S (Daro_2590), AS (Daro_2589), OR1 (Daro_2591), OR2 (Daro_2592), and OR3 (Daro_2593). The present disclosure also provides for host cells including the recombinant nucleic acid having a nucleic acid sequence encoding pcrP (Daro_2587); alone or in combination with one or more of the recombinant nucleic acid having nucleic acid sequences encoding nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), S (Daro_2590), AS (Daro_2589), OR1 (Daro_2591), OR2 (Daro_2592), and OR3 (Daro_2593). The present disclosure also provides for host cells including the recombinant nucleic acid having a nucleic acid sequence encoding S (Daro_2590); alone or in combination with one or more of the recombinant nucleic acid having nucleic acid sequences encoding nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), AS (Daro_2589), OR1 (Daro_2591), OR2 (Daro_2592), and OR3 (Daro_2593). The present disclosure also provides for host cells including the recombinant nucleic acid having a nucleic acid sequence encoding AS (Daro_2589); alone or in combination with one or more of the recombinant nucleic acid having nucleic acid sequences encoding nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), OR1 (Daro_2591), OR2 (Daro_2592), and OR3 (Daro_2593). The present disclosure also provides for host cells including the recombinant nucleic acid having a nucleic acid sequence encoding OR1 (Daro_2591); alone or in combination with one or more of the recombinant nucleic acid having nucleic acid sequences encoding nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR2 (Daro_2592), and OR3 (Daro_2593). The present disclosure also provides for host cells including the recombinant nucleic acid having a nucleic acid sequence encoding OR2 (Daro_2592); alone or in combination with one or more of the recombinant nucleic acid having nucleic acid sequences encoding nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), and OR3 (Daro_2593). The present disclosure also provides for host cells including the recombinant nucleic acid having a nucleic acid sequence encoding OR3 (Daro_2593); alone or in combination with one or more of the recombinant nucleic acid having nucleic acid sequences encoding nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), and OR2 (Daro_2592).

In certain embodiments, the unmodified host cell does not have (per)chlorate-reducing activity. However, upon transformation with one or more recombinant nucleic acids of the present disclosure, the transformed host cell has (per)chlorate-reducing activity.

The present disclosure also provides for host cells including two or more, three or more, four or more, five or more, six or more, seven or more, eight or more, nine or more, 10 or more, 11 or more, 12 or more, 13 or more, 14 or more, 15 or more, or all 16 of the recombinant nucleic acids containing nucleic acid sequences encoding nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593).

In certain embodiments, host cells that do not normally reduce (per)chlorate, can be made to reduce (per)chlorate by transforming the cell with a vector containing one or more, two or more, three or more, four or more, five or more, six or more, seven or more, eight or more, nine or more, 10 or more, 11 or more, 12 or more, 13 or more, 14 or more, 15 or more, or all 16 of the recombinant nucleic acids containing nucleic acid sequences encoding nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593); and culturing the transformed cell under suitable conditions to express the one or more, two or more, three or more, four or more, five or more, six or more, seven or more, eight or more, nine or more, 10 or more, 11 or more, 12 or more, 13 or more, 14 or more, 15 or more, or all 16 recombinant nucleic acids, where expression of the nucleic acids is sufficient for the host cell to reduce (per)chlorate.

The transformed host cell may be, for example, from Escherichia, Shewanella, Pseudomonas, Proteus, Ralstonia, Streptomyces, Staphylococcus, Lactococcus, Bacillus, Saccharomyces, Schizosaccharomyces, Yarrowia, Hansenula, Kluyveromyces, Pichia pastoris, Aspergillus, Chrysosporium, Trichoderma, Magnetospirillum, Azospirillum, Azospira, Dechlorobacter, Propionivibrio, Wolinella, Moorella, Sporomusa, Rhodobacter, and Alicycliphilus. Various suitable host cells are well-known in the art and may be used in the methods of the present disclosure.

### Amino Acid Sequences Encoding DPRB Enzymes

The disclosure also provides for the polypeptide encoded by the DPRB genes nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593), or subsequences thereof. The polypeptides of the present disclosure may contain an amino acid sequence having at least about 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 72%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more, or complete (100%) sequence identity/sequence similarity to the amino acid sequence encoded by the DPRB genes nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593), where the encoded polypeptides retain (per)chlorate-reducing activities or functions.

The polypeptides of the present disclosure can be expressed in and purified from their native host. The polypeptides may also be expressed in and purified from transgenic expression systems. Transgenic expression systems can be prokaryotic or eukaryotic. Transgenic host cells may include yeast and E. coli. Transgenic host cells may secrete the polypeptide out of the host cell. In certain embodiments, the isolated or recombinant polypeptide lacks a signal sequence.

The present disclosure further provides transformed host cells expressing the polypeptide encoded by the amino acid sequence of nar (Af_0174-0176), alone or in combination with one or more of the polypeptides encoded by the amino acid sequences of pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure further provides transformed host cells expressing the polypeptide encoded by the amino acid sequence of pcrA (Daro_2584); alone or in combination with one or more of the polypeptides encoded by the amino acid sequences of nar (Af_0174-0176), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells expressing the polypeptide encoded by the amino acid sequence of pcrB (Daro_2583); alone or in combination with one or more of the polypeptides encoded by the amino acid sequences of nar (Af_0174-0176), pcrA (Daro_2584), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells including expressing the polypeptide encoded by the amino acid sequence of pcrC (Daro_2582); alone or in combination with one or more of the polypeptides encoded by the amino acid sequences of nar (Af_0174-0176), pcrA (Daro_2584), pcrB (Daro_2583), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells expressing the polypeptide encoded by the amino acid sequence of pcrD (Daro_2581); alone or in combination with one or more of the polypeptides encoded by the amino acid sequences of nar (Af_0174-0176), pcrA (Daro_2584), pcrB (Daro_2583), pcrC (Daro_2582), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells expressing the polypeptide encoded by the amino acid sequence of cld (Daro_2580); alone or in combination with one or more of the polypeptides encoded by the amino acid sequences of nar (Af_0174-0176), pcrA (Daro_2584), pcrB (Daro_2583), pcrC (Daro_2582), pcrD (Daro_2581), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells expressing the polypeptide encoded by the amino acid sequence of moaA (Daro_2577); alone or in combination with one or more of the polypeptides encoded by the amino acid sequences of nar (Af_0174-0176), pcrA (Daro_2584), pcrB (Daro_2583), pcrC (Daro_2582), pcrD (Daro_2581), cld (Daro_2580), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells expressing the polypeptide encoded by the amino acid sequence of pcrQ (Daro_2579); alone or in combination with one or more of the polypeptides encoded by the amino acid sequences of nar (Af_0174-0176), pcrA (Daro_2584), pcrB (Daro_2583), pcrC (Daro_2582), pcrD (Daro_2581), cld (Daro_2580), moaA (Daro_2577), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells expressing the polypeptide encoded by the amino acid sequence of pcrO (Daro_2578); alone or in combination with one or more of the polypeptides encoded by the amino acid sequences of nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells expressing the polypeptide encoded by the amino acid sequence of pcrS (Daro_2586); alone or in combination with one or more of the polypeptides encoded by the amino acid sequences of nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrR (Daro_2585), pcrP (Daro_2587), S (Daro_2590), AS (Daro_2589), OR1 (Daro_2591), OR2 (Daro_2592), and OR3 (Daro_2593). The present disclosure also provides for host cells expressing the polypeptide encoded by the amino acid sequence of pcrR (Daro_2585); alone or in combination with one or more of the polypeptides encoded by the amino acid sequences of nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrP (Daro_2587), S (Daro_2590), AS (Daro_2589), OR1 (Daro_2591), OR2 (Daro_2592), and OR3 (Daro_2593). The present disclosure also provides for host cells expressing the polypeptide encoded by the amino acid sequence of pcrP (Daro_2587); alone or in combination with one or more of the polypeptides encoded by the amino acid sequences of nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), S (Daro_2590), AS (Daro_2589), OR1 (Daro_2591), OR2 (Daro_2592), and OR3 (Daro_2593). The present disclosure also provides for host cells expressing the polypeptide encoded by the amino acid sequence of S (Daro_2590); alone or in combination with one or more of the polypeptides encoded by the amino acid sequences of nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), AS (Daro_2589), OR1 (Daro_2591), OR2 (Daro_2592), and OR3 (Daro_2593). The present disclosure also provides for host cells expressing the polypeptide encoded by the amino acid sequence of AS (Daro_2589); alone or in combination with one or more of the polypeptides encoded by the amino acid sequences of nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), OR1 (Daro_2591), OR2 (Daro_2592), and OR3 (Daro_2593). The present disclosure also provides for host cells expressing the polypeptide encoded by the amino acid sequence of OR1 (Daro_2591); alone or in combination with one or more of the polypeptides encoded by the amino acid sequences of nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR2 (Daro_2592), and OR3 (Daro_2593). The present disclosure also provides for host cells expressing the polypeptide encoded by the amino acid sequence of OR2 (Daro_2592); alone or in combination with one or more of the polypeptides encoded by the amino acid sequences of nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), and OR3 (Daro_2593). The present disclosure also provides for host cells expressing the polypeptide encoded by the amino acid sequence of OR3 (Daro_2593); alone or in combination with one or more of the polypeptides encoded by the amino acid sequences of nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), and OR2 (Daro_2592).

In certain embodiments, the unmodified host cell does not have (per)chlorate-reducing activity. However, upon transformation, the host cell expresses the one or more polypeptides of the present disclosure, which results in the transformed host cell having (per)chlorate-reducing activity.

The present disclosure also provides for host cells including two or more, three or more, four or more, five or more, six or more, seven or more, eight or more, nine or more, 10 or more, 11 or more, 12 or more, 13 or more, 14 or more, 15 or more, or 16 of the polypeptides encoded by the nucleic acid sequences of nar (Af_0174-0176), pcrA (Daro_2584), pcrB (Daro_2583), pcrC (Daro_2582), pcrD (Daro_2581), cld (Daro_2580), moaA (Daro_2577), pcrQ (Daro_2579), pcrO (Daro_2578), pcrS (Daro_2586), pcrR (Daro_2585), pcrP (Daro_2587), S (Daro_2590), AS (Daro_2589), OR1 (Daro_2591), OR2 (Daro_2592), and OR3 (Daro_2593).

In certain embodiments, the one or more polypeptides of the present disclosure may be secreted from the transgenic host cell.

### Variants, Sequence Identity, and Sequence Similarity

Methods of alignment of sequences for comparison are well-known in the art. For example, the determination of percent sequence identity between any two sequences can be accomplished using a mathematical algorithm. Such mathematical algorithms include, for example, the algorithm of Myers and Miller (1988) CABIOS 4:11 17; the local homology algorithm of Smith et al. (1981) Adv. Appl. Math. 2:482; the homology alignment algorithm of Needleman and Wunsch (1970) J. Mol. Biol. 48:443 453; the search-for-similarity-method of Pearson and Lipman (1988) Proc. Natl. Acad. Sci. 85:2444 2448; the algorithm of Karlin and Altschul (1990) Proc. Natl. Acad. Sci. USA 872264, modified as in Karlin and Altschul (1993) Proc. Natl. Acad. Sci. USA 90:5873 5877.

Computer implementations of these mathematical algorithms can be utilized for comparison of sequences to determine sequence identity. Such implementations include, for example: CLUSTAL in the PC/Gene program (available from Intelligenetics, Mountain View, Calif.); the ALIGN program (Version 2.0) and GAP, BESTFIT, BLAST, FASTA, and TFASTA in the Wisconsin Genetics Software Package, Version 8 (available from Genetics Computer Group (GCG), 575 Science Drive, Madison, Wis., USA). Alignments using these programs can be performed using the default parameters. The CLUSTAL program is well described by Higgins et al. (1988) Gene 73:237 244 (1988); Higgins et al. (1989) CABIOS 5:151 153; Corpet et al. (1988) Nucleic Acids Res. 16:10881 90; Huang et al. (1992) CABIOS 8:155 65; and Pearson et al. (1994) Meth. Mol. Biol. 24:307 331. The ALIGN program is based on the algorithm of Myers and Miller (1988) supra. A PAM120 weight residue table, a gap length penalty of 12, and a gap penalty of 4 can be used with the ALIGN program when comparing amino acid sequences. The BLAST programs of Altschul et al. (1990) J. Mol. Biol. 215:403 are based on the algorithm of Karlin and Altschul (1990) supra. BLAST nucleotide searches can be performed with the BLASTN program, score=100, wordlength=12, to obtain nucleotide sequences homologous to a nucleotide sequence encoding a protein of the invention. BLAST protein searches can be performed with the BLASTX program, score=50, wordlength=3, to obtain amino acid sequences homologous to a protein or polypeptide of the invention. To obtain gapped alignments for comparison purposes, Gapped BLAST (in BLAST 2.0) can be utilized as described in Altschul et al. (1997) Nucleic Acids Res. 25:3389. Alternatively, PSI-BLAST (in BLAST 2.0) can be used to perform an iterated search that detects distant relationships between molecules. See Altschul et al. (1997) supra. When utilizing BLAST, Gapped BLAST, or PSI-BLAST, the default parameters of the respective programs (e.g., BLASTN for nucleotide sequences, BLASTX for proteins) can be used. See http://www.ncbi.nlm.nih.gov. Alignment may also be performed manually by inspection.

As used herein, sequence identity or identity in the context of two nucleic acid or polypeptide sequences makes reference to the residues in the two sequences that are the same when aligned for maximum correspondence over a specified comparison window. When percentage of sequence identity is used in reference to proteins, it is recognized that residue positions which are not identical and often differ by conservative amino acid substitutions, where amino acid residues are substituted for other amino acid residues with similar chemical properties (e.g., charge or hydrophobicity), do not change the functional properties of the molecule. When sequences differ in conservative substitutions, the percent sequence identity may be adjusted upwards to correct for the conservative nature of the substitution. Sequences that differ by such conservative substitutions are said to have sequence similarity or similarity. Means for making this adjustment are well-known to those of skill in the art. Typically this involves scoring a conservative substitution as a partial rather than a full mismatch, thereby increasing the percentage sequence identity. Thus, for example, where an identical amino acid is given a score of 1 and a non-conservative substitution is given a score of zero, a conservative substitution is given a score between zero and 1. The scoring of conservative substitutions is calculated, e.g., as implemented in the program PC/GENE (Intelligenetics, Mountain View, Calif.).

### Methods of Controlling Souring

The methods of the present disclosure involve approaches for controlling or regulating souring in a system. Souring is generally considered to be controlled in a system when souring is inhibited to some degree. For example, souring may be controlled in a system when souring is decreasing (e.g. hydrogen sulfide levels in the system are decreasing over time) or when souring is being maintained at a constant level (e.g. hydrogen sulfide levels in the system are at a constant level over time). Accordingly, souring may be considered to be controlled in a system when souring is not increasing (e.g. when hydrogen sulfide levels in the system are not increasing over time).

In some embodiments, the methods of the present disclosure provide an approach to controlling souring in a system that occurs in three phases: (i) inhibition of SRM-mediated sulfate reduction by (per)chlorate and thus inhibition of sulfide production by SRM; (ii) re-oxidation of any sulfide produced by SRM to sulfur, this oxidation being mediated by (per)chlorate-reducing bacteria (DPRB), and (iii) inhibition of (per)chlorate respiration by the DPRB to prevent consumption of the souring inhibitor (perchlorate) by the DPRB to allow for continued and/or enhanced inhibition of souring in the system.

In some embodiments, the methods of the present disclosure provide an approach to controlling souring in a system by contacting the system with a compound that is an inhibitor of (per)chlorate respiration such as, for example, bromate, iodate, and/or periodate. Bromate, iodate, and periodate are also inhibitors of sulfate-reducing microorganisms and thus are suitable for use in controlling souring in a system independently.

After being subjected to a souring control treatment of the present disclosure, the sulfate-reducing activity of a sulfate-reducing microorganism may be reduced by, for example, at least about least about 5%, at least about 10%, at least about 15%, at least about 20%, at least about 25%, at least about 30%, at least about 35%, at least about 40%, at least about 45%, about 50%, at least about 55%, at least about 60%, at least about 65%, at least about 70%, at least about 75%, at least about 80%, at least about 85%, at least about 90%, at least about 95%, at least about 99%, or about 100% as compared to a corresponding control SRM not subjected to a souring control treatment of the present disclosure.

After being subjected to a souring control treatment of the present disclosure, a sulfate-reducing microorganism may have its growth or growth rate reduced by, for example, at least about least about 5%, at least about 10%, at least about 15%, at least about 20%, at least about 25%, at least about 30%, at least about 35%, at least about 40%, at least about 45%, about 50%, at least about 55%, at least about 60%, at least about 65%, at least about 70%, at least about 75%, at least about 80%, at least about 85%, at least about 90%, at least about 95%, at least about 99%, or about 100% as compared to a corresponding control SRM not subjected to a souring control treatment of the present disclosure.

Chlorine Oxyanions and Compounds Yielding Chlorine Oxyanions

Certain methods of the present disclosure involve adding, to a system, chlorine oxyanions or compounds yielding chlorine oxyanions to decrease the amount of sulfide-containing compounds in the system. In some embodiments, the chlorine oxyanions can be added in a batch or a continuous manner. The method of addition depends on the system being treated. For example, in embodiments where the system is a single oil well, the chlorine oxyanions can be added in a single batch injection. In other embodiment where the system is an entire oil-recovery system, the chlorine oxyanions can be added in a continuous process.

Chlorine oxyanions may include, for example, hypochlorite, chlorine dioxide, chlorite, chlorate, perchlorate, and mixtures thereof.

In embodiments where the method is used to decrease the amount of sulfide-containing compounds in an oil reservoir, the chlorine oxyanions can be added into injected water at the beginning of the flooding process. Alternatively, the chlorine oxyanions can also be added to makeup waters out in the field after souring has been observed. In other embodiments, the chlorine oxyanions can be added at the wellhead.

In some embodiments, chlorine oxyanions are added to CO₂ storage wells to reduce or inhibit the formation of sour gas by SRM present in the storage wells. In this manner, chlorine oxyanions can protect the storage wells from the metal corrosion and concrete corrosion that may occur as the result of sour gas formation.

In the present disclosure, the chlorine oxyanions added to a system are present in the system at a concentration sufficient to stimulate (per)chlorate-reducing activity of DPRB that are present in the system. This concentration is dependent upon the parameters of the system being treated by the provided method. For example, characteristics of the system, such as its volume, surrounding pH, temperature, sulfate concentration, etc., will dictate the appropriate concentration of chlorine oxyanions needed to stimulate the (per)chlorate-reducing activity of the DPRB. Without wishing to be bound by theory, it is believed in a system with a ratio of three S²⁻ ions to one ClO₃⁻ ion, all of the sulfide in the system will be completely oxidized to elemental sulfur. Additionally, it is believed that this ratio changes to 4:1 with perchlorate, and 2:1 with chlorite or chlorine dioxide. Accordingly, in some embodiments, the chlorine oxyanions added to the system are at a ratio with sulfide that is sufficient to completely oxidize the sulfide to elemental sulfur.

In embodiments where perchlorate (ClO₄⁻) is added, the perchlorate can be added in an amount that is at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 80%, at least 85%, at least 90%, at least 95%, or at least 100% of the amount (i.e., concentration) of sulfate present in the system. Methods for determining the concentration of sulfate present in a system, such as oil reservoir, are well known in the art. For example, sea water, which can be used as floodwater in an oil reservoir, generally has a sulfate concentration of about 20-30 mM.

The chlorine oxyanions added to the system may be in various forms. For example, the counter ion is not critical and accordingly various forms of the chlorine oxyanions may be added so long as the ions perform their desired function. Suitable counter ions may include, for example, chlorine oxyanion acids and salts of sodium, potassium, magnesium, calcium, lithium, ammonium, silver, rubidium, and cesium. Compounds which yield chlorine oxyanions upon addition to the system may also be used in the methods of the present disclosure.

Additional Inhibitors of Souring

Other chemical compounds, such as nitrates and nitrites, may also be added to the systems of the present disclosure to control souring. Certain aspects of the present disclosure relate to adding additional nutrients to a system of the present disclosure to stimulate (per)chlorate-reducing activity of DPRB of the present disclosure, and to adding additional anions, such as nitrate (NO₃⁻) and/or nitrite (NO₂⁻) to further inhibit SRM present in the system. In some embodiments, nutrients that stimulate (per)chlorate-reducing activity of the DPRB may be added to systems of the present disclosure. Examples of such nutrients include, for example, molybdenum, additional carbon sources, and/or phosphorous ions (e.g., phosphite and phosphate).

Nitrite, in small amounts, is very toxic to sulfate-reducing microorganisms. Accordingly, nitrite may be added to the system in combination with (per)chlorate (or other chlorine oxyanion) to inhibit sulfate-reducing microorganisms, thereby inhibiting sulfidogenesis and controlling souring. In certain embodiments, the nitrite or nitrate is added at a concentration sufficient to inhibit the sulfate-reducing microorganisms and thus inhibit souring. Generally, the nitrite or nitrate can be added in combination with (per)chlorate at a (per)chlorate:nitrite ratio of at least 10:1, at least 20:1, at least 30:1, at least 40:1, at least 50:1, at least 60:1, at least 70:1, at least 80:1, at least 90:1, at least 100:1, at least 110:1, at least 120:1, at least 130:1, at least 140:1, at least 150:1, at least 160:1, at least 170:1, at least 180:1, at least 190:1, at least 200:1, or more. In certain preferred embodiments, (per)chlorate and nitrite are added in a ratio of 100:1. For example 10 mM of (per)chlorate and 100 μM of nitrite or nitrate may be added to the system.

In some embodiments, nitrate-reducing microorganisms and nitrate may also be added to a system to expand the population of nitrate-reducing microorganisms in the system to further control souring. Nitrate-reducing bacteria can reduce chlorate to chlorite, and it has been shown that, in pure culture, the produced chlorite can kill the nitrate-reducing bacteria. However, without wishing to be bound by theory, it is believed that in a sulfidogenic environment, such as an oil reservoir, the chlorite can inhibit sulfate-reducing microorganisms. Accordingly, in certain embodiments, nitrate may be added to a system of the present disclosure, such as an oil reservoir, in an amount sufficient to stimulate nitrate reduction to expand the population of nitrate-reducing microorganisms in the system. Once the microbial population has been expanded, chlorine oxyanions, such as (per)chlorate, can be added to biogenically produce chlorite in an amount sufficient to inhibit sulfate-reducing microorganisms and souring.

Removal of Sulfide Contaminants from the System

As discussed above, DPRB of the present disclosure can act to oxidize sulfides, such as H₂S produced from sulfate-reducing microorganisms, to elemental sulfur. Following such oxidation, elemental sulfur may be removed from systems of the present disclosure. Accordingly, the present disclosure also provides systems for removing sulfide contaminants from sulfide-containing compounds. Sulfide-containing compounds are a common contaminant in products such as, for example, gases, oil, hydrocarbons, and wastewaters. It is common for processing plants, such as refineries, gas processing plants, chemical processing plants, and wastewater treatment plants, to employ sulfide scrubbers to remove sulfide contaminants. Scrubbers can either be physical solvents that remove sulfide by straight absorption, or they can include amines that remove sulfide through a chemical reaction. For example, amine scrubbing units utilize aqueous solutions of various alkylamines (commonly referred to simply as amines) to remove hydrogen sulfide from gases. A typical amine scrubbing unit includes an absorber unit and a regenerator unit. In the absorber, the downflowing amine solution absorbs H₂S from the upflowing sour gas to produce a sweetened gas stream (i.e., an H₂S-free gas) as a product and an amine solution rich in the absorbed H₂S. The resultant “rich” amine is then routed into the regenerator (a stripper with a reboiler) to produce regenerated or “lean” amine that is recycled for reuse in the absorber. The stripped overhead gas from the regenerator is concentrated H₂S. This H₂S-rich stripped gas stream is then usually routed into a Claus process to convert it into elemental sulfur.

Advantageously, the DPRB of the present disclosure may be used to remove and/or minimize the accumulation of sulfide contaminants in processing plants, thus removing the need for such sulfide scrubbers. Additionally, the DPRB of the present disclosure completely oxidize sulfides to elemental sulfur, thus removing the need for additional processes that convert the concentrated H₂S-rich gas into elemental sulfur. For example, the DRPB of the present disclosure may be used in an oil refinery. The DRPB can be injected into a container, such as a tank, that contains the contaminated oil. The contaminated oil can then be incubated with the DRPB in the container as part of the refining process.

Accordingly, certain embodiments of the present disclosure provide a system for refining a compound containing a sulfide contaminant, including a container that includes (per)chlorate-reducing bacteria and a compound containing a sulfide contaminant, where the system does not contain a sulfide scrubber. Various systems for refining a sulfide-containing compound are known in the art. Refineries include, for example, oil refineries and gas processing plants. Other embodiments of the present disclosure provide a chemical plant for producing a compound containing a sulfide contaminant, including a container that includes (per)chlorate-reducing bacteria and a compound containing a sulfide contaminant, where the system does not contain a sulfide scrubber. Various chemical plants are known in the art and these plants manufacture or processes chemicals. Chemical plants include, for example, hydrocarbon processing plants and petrochemical plants. Further embodiments of the present disclosure provide a wastewater treatment plant for treating wastewater containing a sulfide contaminant, including a container that includes (per)chlorate-reducing bacteria and wastewater containing a sulfide contaminant, where the system does not contain a sulfide scrubber. Various wastewater treatment plants are known in the art may be used in the methods of the present disclosure.

In some embodiments, the container is located within or in close proximity to any of disclosed refineries or plants. In other embodiments, the container is located at a location that is geographically distinct from the refinery or plant. For example, in the case of an oil refinery, the container may be located near an oil well or oil field. Alternatively, the container may be part of a conveyance vehicle that transports the sulfide-containing compound to the refinery or plant.

In certain embodiments, the compound containing a sulfide contaminant is selected from a gas, oil, a hydrocarbon, and a mixture thereof. The sulfide contaminant may be present in any raw material or starting material that is used in the refining, treatment, or production process of any of the systems of the present disclosure. Alternatively, the sulfide contaminant may be a byproduct of the refining, treatment, or production process of any of the systems of the present disclosure. In certain embodiments, the sulfide contaminant is hydrogen sulfide. In other embodiments, the container further contains chlorine oxyanions. Preferably, the chlorine oxyanions are chlorine dioxide, chlorite, chlorate, perchlorate, or a mixture thereof. In some embodiments, the (per)chlorate-reducing bacteria are Dechloromonas aromatica or Dechloromarinus strain NSS.

In other embodiments, (per)chlorate-reducing bacteria are used to inhibit sour gas formation in CO₂ storage wells. In this manner, (per)chlorate-reducing bacteria can protect the storage wells from the metal corrosion and concrete corrosion that may occur as the result of sour gas formation.

Further aspects of the present disclosure also relate to a container for storing a compound containing a sulfide contaminant, that includes (per)chlorate-reducing bacteria and a compound containing a sulfide contaminant. In some embodiments, the container further contains chlorine oxyanions. Preferably, the chlorine oxyanions are chlorine dioxide, chlorite, chlorate, perchlorate, or a mixture thereof. In other embodiments, the sulfide contaminant is hydrogen sulfide. In some embodiments, the compound containing a sulfide contaminant is selected from a gas, oil, a hydrocarbon, and a mixture thereof. In some embodiments, the (per)chlorate-reducing bacteria are Dechloromonas aromatica or Dechloromarinus strain NSS.

Inhibitors of (Per)Chlorate Respiration

Certain methods discussed above relate to the addition of chlorine oxyanions to a system containing sulfate-reducing microorganisms (SRM) and (per)chlorate-reducing bacteria (DPRB) in an effort to control souring in the system. The DPRB may oxidize sulfides, such as H₂S produced from sulfate-reducing microorganisms, to elemental sulfur. Once the oxidation is sufficiently complete, the elemental sulfur may be removed from the system. However, as discussed above, once sulfide oxidation is sufficiently complete and removed from the system, continued activity of DPRB is unwarranted and costly as they result in the consumption of the SRM inhibitor (perchlorate) at the expense of organics (hydrocarbons) in the system and potentially increase the possibility of undesirable biomass plugging.

Accordingly, in some embodiments, the present disclosure provides methods of enhancing the inhibition of souring in a system by adding an inhibitor of (per)chlorate respiration to the system after the sulfide-oxidizing activity of DPRB in the system is deemed sufficiently complete. In some embodiments, an inhibitor of (per)chlorate respiration may be added to a system of the present disclosure at the same time that a chlorine oxyanion is added to the system. For example, an inhibitor or (per)chlorate respiration and a chlorine oxyanion may be added to a system together if, for example, the system has not yet soured, such that both SRM activity and DPRB activity are inhibited. The timing for adding the various compounds of the present disclosure, and/or adding compounds in particular combinations at particular times, may depend on various parameters, such as the souring status of the system, as will be readily appreciated by one of skill in the art.

Various inhibitors of (per)chlorate respiration may be used in the methods of the present disclosure. For example, bromate, periodate, and iodate may be used as compounds that are inhibitors of (per)chlorate respiration.

Further, methods of identifying a compound that may act as an inhibitor of (per)chlorate respiration are well-known in the art and are described herein. For example, inhibitors of (per)chlorate respiration could be identified through stochastic sampling of chemical compounds or by structure-based design of appropriate chemical structures and assessing their ability to inhibit DPRB respiration. Other identification methods include, for example, analyzing the ability of a compound to specifically inhibit enzymes involved in the (per)chlorate respiration pathway, such as perchlorate reductase (Pcr), chlorate reductase (Clr), chlorite dismutase (Cld), and cytochrome C oxidase (Cox). The latter approach to identifying inhibitors is commonly used by the pharmaceutical and agricultural chemical industries. Further, structural analogs of perchlorate and chlorate, the electron acceptors utilized by perchlorate-reducing microorganisms, may be suitable candidate compounds to test for their ability to inhibit (per)chlorate respiration.

In some embodiments, inhibitors of (per)chlorate respiration may also act as inhibitors of sulfate-reducing microorganisms. For example, the compound bromate is an inhibitor of both DPRB and an inhibitor of SRM. In this sense, inhibitors of (per)chlorate respiration may serve to inhibit both (per)chlorate respiration of DPRB and sulfate-reducing activity of SRM. Inhibitors with such qualities may thus have potential to even further enhance the inhibition of souring in a system according to the methods of the present disclosure.

The addition of inhibitors of (per)chlorate respiration to a system of the present disclosure may be accomplished in a variety of ways. In some embodiments, one or more inhibitors of (per)chlorate respiration can be added in a batch or a continuous manner. The method of addition depends on the system being treated. For example, in embodiments where the system is a single oil well, the inhibitors of (per)chlorate respiration can be added in a single or multiple sequential batch injections. In other embodiment where the system is an entire oil-recovery system, the inhibitors of (per)chlorate respiration can be added in a continuous process.

In embodiments where the method is used to control (e.g. decrease) the amount of sulfide-containing compounds in an oil reservoir, the inhibitors of (per)chlorate respiration can be added into injected water during the flooding process after the addition of chlorine oxyanions into the system. Alternatively, the inhibitors of (per)chlorate respiration can also be added to makeup waters out in the field after souring has been observed. In other embodiments, the inhibitors of (per)chlorate respiration can be added at the wellhead.

In further embodiments, inhibitors of (per)chlorate respiration of the present disclosure are added to CO₂ storage wells treated with (per)chlorate to reduce or inhibit the formation of sour gas by sulfate-reducing microorganisms or sulfur oxidizing bacteria present in the storage wells. In this manner, the chemical compounds can protect the storage wells from the metal corrosion and concrete corrosion that may occur as the result of sour gas formation.

An inhibitor of (per)chlorate respiration should be present in the system at a concentration which is sufficient to inhibit souring and/or inhibit (per)chlorate respiration activity of DPRB in a unit volume of the system. Certain inhibitors of (per)chlorate respiration may also act as inhibitors of sulfate-reducing microorganisms, and thus such inhibitors should be present in the system at a concentration which is sufficient to inhibit the activity of sulfate-reducing microorganisms. The concentration of an inhibitor of (per)chlorate respiration present in the system, or in a specific unit volume of the system may be, for example, at least about 0.01 mM, at least about 0.02 mM, at least about 0.03 mM, at least about 0.04 mM, at least about 0.05 mM, at least about 0.06 mM, at least about 0.07 mM, at least about 0.08 mM, at least about 0.09 mM, at least about 0.1 mM, at least about 0.2 mM, at least about 0.3 mM, at least about 0.4 mM, at least about 0.5 mM, at least about 0.6 mM, at least about 0.7 mM, at least about 0.8 mM, at least about 0.9 mM, at least about 1 mM, at least about 1.5 mM, at least about 2 mM, at least about 2.5 mM, at least about 3 mM, at least about 3.5 mM, at least about 4 mM, at least about 4.5 mM, 5 mM, at least about 5.5 mM, at least about 6 mM, at least about 6.5 mM, at least about 7 mM, at least about 7.5 mM, at least about 8 mM, at least about 8.5 mM, at least about 9 mM, at least about 9.5 mM, at least about 10 mM, at least about 11 mM, at least about 12 mM, at least about 13 mM, at least about 14 mM, at least about 15 mM, at least about 16 mM, at least about 17 mM, at least about 18 mM, at least about 19 mM, or at least about 20 mM or more. In some embodiments, the concentration of an inhibitor of (per)chlorate respiration present in a system is about 0.5 mM.

The concentration of an inhibitor of (per)chlorate respiration present in the system, or in a specific unit volume of the system may be, for example, about 0.01 mM to about 0.05 mM, about 0.05 mM to about 0.1 mM, about 0.1 mM to about 0.25 mM, about 0.25 mM to about 0.5 mM, about 0.5 mM to about 1 mM, about 1 mM to about 1.5 mM, about 1.5 mM to about 2 mM, about 2 mM to about 2.5 mM, about 2.5 mM to about 3 mM, about 3 mM to about 3.5 mM, about 3.5 mM to about 4 mM, about 4 mM to about 4.5 mM, about 4.5 mM to about 5 mM, about 0.1 mM to about 5 mM, about 0.5 mM to about 5 mM, about 1 mM to about 5 mM, about 1.5 mM to about 5 mM, about 2.5 mM to about 5 mM, about 0.01 mM to about 10 mM, about 0.01 mM to about 5 mM, about 0.01 mM to about 2.5 mM, about 0.01 mM to about 1 mM, about 0.05 mM to about 10 mM, about 0.05 mM to about 5 mM, about 0.05 mM to about 2.5 mM, about 0.05 mM to about 1 mM, about 0.1 mM to about 10 mM, about 0.5 mM to about 10 mM, about 1 mM to about 10 mM, about 2 mM to about 10 mM, about 0.1 mM to about 20 mM, about 0.5 mM to about 20 mM, about 1 mM to about 20 mM, or about 5 mM to about 20 mM. In some embodiments, the concentration of an inhibitor of (per)chlorate respiration present in a system is in the range of about 0.05 mM to about 10 mM.

After being added to a system of the present disclosure, an inhibitor of (per)chlorate respiration in the system may reduce the perchlorate-reducing activity of DPRB by, for example, at least about 5%, at least about 10%, at least about 15%, at least about 20%, at least about 25%, at least about 30%, at least about 35%, at least about 40%, at least about 45%, about 50%, at least about 55%, at least about 60%, at least about 65%, at least about 70%, at least about 75%, at least about 80%, at least about 85%, at least about 90%, at least about 95%, at least about 99%, or about 100% as compared to a corresponding control DPRB not contacted with an inhibitor of (per)chlorate respiration.

After being added to a system of the present disclosure, an inhibitor of (per)chlorate respiration in the system may reduce the growth or growth rate of DPRB by, for example, at least about 5%, at least about 10%, at least about 15%, at least about 20%, at least about 25%, at least about 30%, at least about 35%, at least about 40%, at least about 45%, about 50%, at least about 55%, at least about 60%, at least about 65%, at least about 70%, at least about 75%, at least about 80%, at least about 85%, at least about 90%, at least about 95%, at least about 99%, or about 100% as compared to a corresponding control DPRB not contacted with an inhibitor of (per)chlorate respiration.

After being added to a system of the present disclosure, an inhibitor of (per)chlorate respiration in the system may reduce the sulfate-reducing activity of SRM by, for example, at least about 5%, at least about 10%, at least about 15%, at least about 20%, at least about 25%, at least about 30%, at least about 35%, at least about 40%, at least about 45%, about 50%, at least about 55%, at least about 60%, at least about 65%, at least about 70%, at least about 75%, at least about 80%, at least about 85%, at least about 90%, at least about 95%, at least about 99%, or about 100% as compared to a corresponding control SRM not contacted with an inhibitor of (per)chlorate respiration.

After being added to a system of the present disclosure, an inhibitor of (per)chlorate respiration in the system may reduce the sulfide-producing activity of SRM by, for example, at least about 5%, at least about 10%, at least about 15%, at least about 20%, at least about 25%, at least about 30%, at least about 35%, at least about 40%, at least about 45%, about 50%, at least about 55%, at least about 60%, at least about 65%, at least about 70%, at least about 75%, at least about 80%, at least about 85%, at least about 90%, at least about 95%, at least about 99%, or about 100% as compared to a corresponding control SRM not contacted with an inhibitor of (per)chlorate respiration.

After being added to a system of the present disclosure, an inhibitor of (per)chlorate respiration in the system may reduce the growth or growth rate of SRM by, for example, at least about 5%, at least about 10%, at least about 15%, at least about 20%, at least about 25%, at least about 30%, at least about 35%, at least about 40%, at least about 45%, about 50%, at least about 55%, at least about 60%, at least about 65%, at least about 70%, at least about 75%, at least about 80%, at least about 85%, at least about 90%, at least about 95%, at least about 99%, or about 100% as compared to a corresponding control SRM not contacted with an inhibitor of (per)chlorate respiration.

Applicants have also shown that certain inhibitors of (per)chlorate respiration of the present disclosure such as, for example, bromate, iodate, and periodate, may also act as inhibitors of sulfate-reducing microorganisms. Accordingly, the present disclosure also provides methods for controlling souring including providing a system including one or more sulfate-reducing microorganisms, and contacting the system with one or more compounds selected from the group including bromate, iodate, and periodate, where the one or more compounds are present in the system at a concentration sufficient to inhibit souring in the system. In this sense, certain inhibitors of (per)chlorate respiration of the present disclosure (e.g. bromate, iodate, and periodate) may be added to a system of the present disclosure in an effort to control souring in the system. Each of these compounds may be added to the system alone or they may be added in various combinations, as will be readily understood by one of skill in the art. Further, the present disclosure also provides for precursor compounds which yield one or more of bromate, iodate, and periodate. A precursor compound which yields one or more of bromate, iodate, and periodate may be added to a system of the present disclosure. Various precursor compounds which may yield bromate, iodate, or periodate are well-known in the art and are described herein.

In some embodiments, a (per)chlorate respiration inhibitor (e.g. bromate, iodate, and periodate) may be added to a system of the present disclosure in conjunction with a chlorine oxyanion such as, for example, (per)chlorate. In some embodiments, a (per)chlorate respiration inhibitor (e.g. bromate, iodate, and periodate) may be added to a system of the present disclosure in conjunction with a (per)chlorate-reducing bacteria. In some embodiments, a (per)chlorate respiration inhibitor (e.g. bromate, iodate, and periodate) may be added to a system of the present disclosure in conjunction with a chlorine oxyanion such as, for example, (per)chlorate, and a (per)chlorate-reducing bacteria.

Inhibition of Souring

In some embodiments, the approaches to controlling souring as disclosed herein should be carried out such that they are sufficient to inhibit souring in a unit volume of the system. A unit volume of a system is generally a specific volume at a given region within the system. One of skill in the art would appreciate that a unit volume experiencing inhibited souring relative to other comparable systems or other regions or unit volumes within the same system may vary. For example, in embodiments where the system is an oil reservoir, the unit volume may be the volume encompassed by an injection well. In some embodiments, the unit volume may be the volume encompassed by a production well. In some embodiments, the unit volume may by the total volume of the system, such as the total volume of an oil reservoir. The unit volume may also be experiencing inhibition of souring over a time interval. For example, a unit volume may be experiencing inhibition of souring over time if the levels of hydrogen sulfide in that unit volume are not increasing over time such as, for example, over a period of hours or days after treatment with a physical and/or chemical approach for controlling souring of the present disclosure. One of skill in the art would appreciate various approaches which may be used to determine if inhibition of souring is occurring in the system.

A unit volume experiencing inhibition of souring may include, for example, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 99%, or at least about 100% of the total volume of the system.

A unit volume of a system of the disclosure may be considered to be experiencing the inhibition of souring if at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 99%, or at least about 100% of souring activity has been inhibited in the unit volume. In some embodiments, souring in a unit volume of a system contacted with a chlorine oxyanion, such as perchlorate, is inhibited by about 50% or more as compared to a corresponding unit volume in a system not contacted with a chlorine oxyanion. In some embodiments, souring in a unit volume of a system contacted with a chlorine oxyanion, such as perchlorate, followed by contact with an inhibitor of (per)chlorate respiration is inhibited by about 50% or more as compared to a corresponding unit volume in a system not contacted with a chlorine oxyanion and/or an inhibitor of (per)chlorate respiration. In some embodiments, souring in a unit volume of a system contacted with a (per)chlorate respiration inhibitor such as, for example, bromate, iodate, and/or periodate, is inhibited by about 50% or more as compared to a corresponding unit volume in a system not contacted with an inhibitor of (per)chlorate respiration.

Various parameters may be used to assess souring activity, as will be appreciated by one of skill in the art. Parameters used to assess or measure souring activity may include, for example, the production of hydrogen sulfide, the depletion of sulfur or its oxyanions (e.g. sulfate, sulfite, thiosulfate, and sulfur dioxide), the presence and/or degree of fluid contamination, the presence of metal corrosion, and evidence of clogging of the system. Measuring hydrogen sulfide levels is a standard chemical analysis and may be performed using, for example, Draeger tubes or online gas chromatographs. The inhibition of souring in a unit volume of the system may be determined, for example, by comparison to a comparable unit volume in a system not treated according to the methods of the present disclosure, or by comparison of similar unit volumes in a treated system over time.

In some embodiments where an inhibitor of (per)chlorate respiration is added to a system following treatment with a chlorine oxyanion and DPRB, the inhibitor of (per)chlorate respiration is added once sulfide oxidation in the system is sufficiently complete. Sufficiently complete sulfide oxidation is generally the point when sulfide concentrations in a sample volume of the system are determined to be at an acceptable level, or the concentration of hydrogen sulfide present in a sample volume of the system is determined to be at an acceptable level. An acceptable concentration of hydrogen sulfide present in a unit volume of a system may vary. Acceptable hydrogen sulfide concentrations in a unit volume of a system following certain methods of the present disclosure may include, for example, concentrations of hydrogen sulfide that are less than 0.00001 ppm, less than 0.0001 ppm, less than 0.001 pm, less than 0.01 ppm, less than 0.05 ppm, less than 0.1 ppm, less than 0.5 ppm, less than 1 ppm, less than 2 ppm, less than 3 ppm, less than 4 ppm, less than 5 ppm, less than 10 ppm, less than 15 ppm, less than 20 ppm, less than 50 ppm, less than 75 ppm, or less than 100 ppm. The methods of the present disclosure may be capable of reducing the concentration of hydrogen sulfide present in a unit volume of a system of the present disclosure by, for example, about 5%, about 10%, about 15%, about 20%, about 25%, 0%, a 30%, about 35%, about 40%, %, about 50%, about 45%, about 50%, about 55%, about 60%, about 65%, about 70%, about 75%, about 80%, about 85%, about 90%, or about 95% or more.

The timing for adding various compounds of the present disclosure to a system may vary. After one or more agents of the present disclosure are added to a system such as, for example, one or more of a chlorine oxyanion, a (per)chlorate-reducing bacteria, and/or an inhibitor of (per)chlorate respiration, at least about 2 hours, about 4 hours, about 8 hours, about 12 hours, about 24 hours, about two days, about three days, about four days, about five days, about six days, about one week, about two weeks, about three weeks, about one month, about two months, or about three months or longer, for example, may pass before another agent of the present disclosure such as, for example, one or more of a chlorine oxyanion, a (per)chlorate-reducing bacteria, and/or an inhibitor of (per)chlorate respiration, is added to the system.

After adding a chlorine oxyanion and/or a (per)chlorate-reducing bacteria of the present disclosure to a system, the time period which passes before adding an inhibitor of (per)chlorate respiration may be, for example, about 2 hours, about 4 hours, about 8 hours, about 12 hours, about 24 hours, about two days, about three days, about four days, about five days, about six days, about one week, about two weeks, about three weeks, about one month, about two months, or about three months or longer.

Various chemical compounds added to systems of the present disclosure should be capable of inhibiting souring in the system and/or enhancing the inhibition of souring in the system. Methods of the present disclosure involving the addition of chemical compounds to a system may be applicable across various pH values, temperature, and salinity ranges in the system. One of skill in the art would readily be able to determine appropriate methods as described herein depending on the specific environmental parameters of a given system.

### Crude Oil Products

Certain aspects of the present disclosure relate to crude oil products obtained using certain methods of the present disclosure. For example, when the system of the present disclosure is an oil reservoir, the methods of the present disclosure may allow for the inhibition of souring in the system. Crude oil products recovered from an oil reservoir treated according to the methods of the present disclosure may have, for example, reduced sulfide contamination as compared to corresponding crude oil products obtained from an oil reservoir not treated according to the methods of the present disclosure. Crude oil products recovered from an oil reservoir treated according to the methods of the present disclosure may also be easier to obtain/be obtained more efficiently due to, for example, the potential for reduced clogging of the system as compared to corresponding systems not treated according to the methods of the present disclosure. The present disclosure thus provides a crude oil product recovered from a system that was treated according to the methods of the present disclosure.

Crude oil products of the present disclosure may undergo additional refining procedures, as will be readily understood by one of skill in the art. For example, a crude oil product of the present disclosure may be refined into a petroleum product or a gasoline product. Methods of refining crude oil products are well-known to those of skill in the art.

### EXAMPLES

The following examples are offered for illustrative purposes and to aid one of skill in better understanding the various embodiments of the disclosure. The following examples are not intended to limit the scope of the present disclosure in any way.

### Example 1: Identification of Specific Inhibitors of (Per)Chlorate Respiration

This Example demonstrates that bromate, iodate, and periodate are all specific inhibitors of (per)chlorate respiration in dissimilatory (per)chlorate reducing bacteria (DPRB). Further, these compounds were able to inhibit the growth of a sulfate-reducing microorganism at sub-millimolar concentrations.

### Introduction

As described above, Applicants outlined two phases of a (per)chlorate and DPRB-based treatment of a system that is undergoing or has the potential to undergo souring: (i) inhibition of SRM-mediated sulfate reduction by (per)chlorate, and thus inhibition of sulfide production by SRM; and (ii) re-oxidation of any sulfide produced by SRM to sulfur, this oxidation being mediated by (per)chlorate-reducing bacteria (DPRB)(See FIG. 1C). However, once sulfide oxidation is sufficiently complete and removed from the system, without wishing to be bound by theory, it is believed that continued activity of DPRB in the system is unwarranted and costly, as they result in the consumption of the SRM inhibitor ((per)chlorate) at the expense of organics (hydrocarbons) in the reservoir and potentially increase the possibility of undesirable biomass plugging.

To explore methods of preventing continued activity of DPRB in engineered systems following phase (ii) described above, Applicants sought to identify specific inhibitors of (per)chlorate respiration to control the activity of DPRB.

### Materials and Methods

Media and Cultivation Conditions

Desulfovibrio alaskenesis G20 was cultivated in basal Tris-buffered lactate/sulfate media containing 8 mM MgCl₂, 20 mM NH₄Cl, 0.6 mM CaCl₂, 2 mM KH₂PO₄, 0.06 mM FeCl₂, and 30 mM Tris-HCl. 60 mM sodium lactate and 30 mM sodium sulfate were added as electron donor and acceptor, respectively. Trace elements and vitamins were added from stocks according to previously described methods (Price et al., 2013; Mukhopadhyay et al., 2006) and the media was brought to a pH of 7.4 with 0.5 M HCl. The media was degassed with N₂ and either sterile-filtered in an anaerobic chamber for microplates or dispensed into anoxic vials. The incubation temperature for all growth experiments was 30° C. G20 was recovered from 1 mL freezer stocks in 10 mL anoxic basal media in sealed anoxic Hungate tubes with 1 g/L yeast extract and 1 mM sodium sulfide and washed in basal media to remove residual yeast extract prior to inoculation of microplates or tubes for growth experiments.

Azospira suillum strain PS was grown in anoxic bicarbonate buffered basal medium (BBM) (Bruce et al., 1999), pH 6.8 at 37° C. with 10 mM sodium nitrate and varying concentrations of sodium acetate and harvested in late log-phase. BBM contained the following components (per Liter): 0.25 g NH₄Cl, 0.6 g NaH₂PO₄, 0.1 g KCl, and 2.52 g NaHCO₃ with the addition of vitamins and minerals according to Bruce et al., 1999 and 10 mM acetate as an electron donor and either 10 mM perchlorate or 10 mM nitrate as electron acceptor.

Growth Experiments

All oxyanion inhibitors were sodium salts (Sigma). For cultivation of Desulfovibrio in microplates, plates were inoculated in an anaerobic chamber (Coy). Desulfovibrio were resuspended in 2× concentrated anoxic basal media containing 2 mM sodium sulfide and added at a 2× dilution to microplates containing water or aqueous solutions of oxyanion inhibitors. Microplates were filled with compounds aerobically using a Biomek FxP liquid handling robot (Beckman instruments) and allowed to degas in Coy anaerobic chambers for 48 hours prior to inoculation. All microplates were inoculated at an initial OD 600 of 0.02 and the inhibitor IC₅₀s determined by measuring OD 600 after 48 hours of growth. Microplates were sealed with PCR plate seals (VWR) and kept in anoxic BD GasPak anaerobic boxes except when timepoints were being recorded. Data analysis for inhibition experiments was carried out in GraphPad Prism 6 and curves were fit to a standard inhibition log dose-response curve to generate an IC₅₀ value. All IC₅₀s are the mean of at least three biological replicates.

### Results

Applicants reasoned that compounds which are structural analogs of perchlorate and chlorate may be able to compete with binding in the active site of perchlorate reductase and cause inhibition of (per)chlorate respiration. The compounds bromate, periodate, and iodate, which are halogenated structural analogs of perchlorate and chlorate, were selected as potential candidate (per)chlorate respiration inhibitor compounds. To test this, these compounds were separately added, at various concentrations, to the growth media of the canonical (per)chlorate and nitrate reducing organism Azospira suillum PS. In each culture, either perchlorate or nitrate was used as the electron acceptor. “(Per)chlorate reducing cells” were incubated with either bromate, iodate, or periodate in the presence of perchlorate so that perchlorate respiration would occur. “Nitrate reducing cells” were incubated with either bromate, iodate, or periodate in the presence of nitrate so that nitrate respiration would occur. The % maximum growth at 48 hours of Azospira suillum PS in culture in the presence of various concentrations of these compounds was assayed.

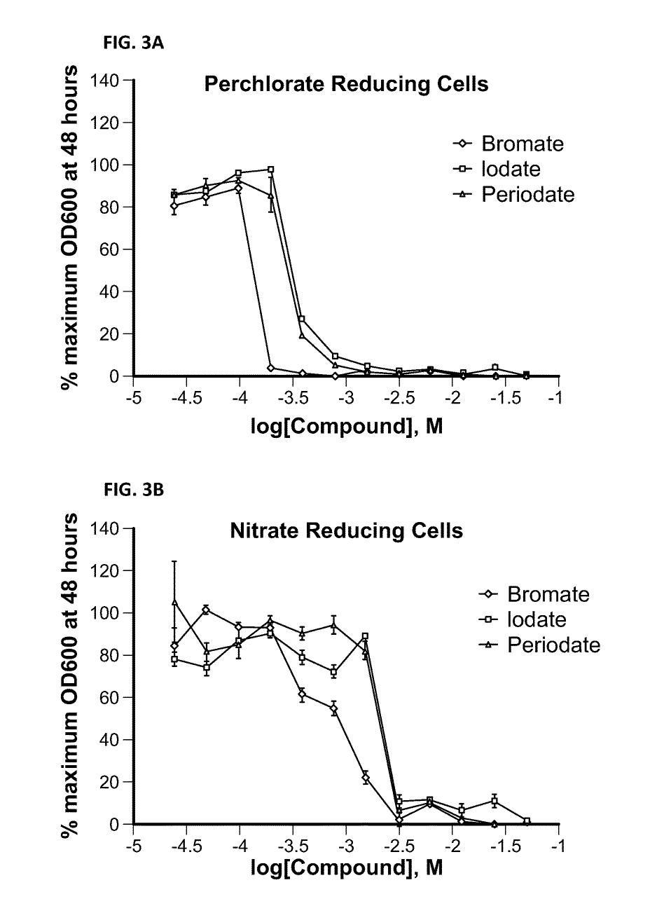

As can be seen in FIG. 3A and FIG. 3B, increasingly high concentrations of bromate, periodate, and iodate eventually led to increased inhibition of growth of Azospira suillum PS when grown in the presence of either perchlorate (FIG. 3A) or nitrate (FIG. 3B). However, at lower concentrations of bromate, periodate, and iodate, these compounds were able to serve as potent inhibitors of (per)chlorate respiration by this organism (as evidenced by inhibition of growth), while these same compounds had minimal impact on nitrate respiration at the same low concentrations.

Various other inhibitor candidate oxyanions were tested to see if they could inhibit the growth of both Azospira suillum PS, using either nitrate or perchlorate as the electron acceptor, as well as inhibit the growth of the canonical sulfate-reducing organism Desulfovibrio alaskensis G20. These results are presented in Table 2 below.

TABLE 2
IC₅₀ of inhibitor against growth of Desulfovibrio alaskensis G20
with sulfate as electron acceptor or growth of Azospira suillum PS with
nitrate or perchlorate as electron acceptor (mM)

| | Desulfovibrio | | |
|---|---|---|---|
| | alaskensis G20 | Azospira suillum | Azospira suillum |
| | with SO₄²⁻ | PS with NO₃⁻ | PS with ClO₄⁻ |
| NO₃⁻ | 70.38 | Growth substrate | Growth substrate |
| ClO₄⁻ | 22.23 | Growth substrate | Growth substrate |
| ClO₃⁻ | 10.44 | Growth substrate | Growth substrate |
| SO₄²⁻ | Growth substrate | 96.41 | 85.92 |
| SO₃⁻ | Growth substrate | 21.59 | 20.47 |
| FPO₃²⁻ | 0.1217 | >50 | 34.71 |
| NO₂⁻ | 0.9254 | 1.144 | 3.86 |
| ClO₂⁻ | <1 mM | 1.144 | 1.325 |
| IO₃⁻ | <1 mM | 186.4 | 2.92 |
| BrO₃⁻ | <1 mM | 48.97 | <1 mM |
| IO₄⁻ | <1 mM | 68.34 | 2.969 |

From Table 2, it was seen that the concentration of bromate (BrO₃⁻), iodate (IO₃⁻), and periodate (IO₄⁻) required to inhibit 50% of Azospira suillum PS growth (IC₅₀, measured in mM) was an order of magnitude less during (per)chlorate respiration than during nitrate respiration, suggesting that these compounds are specific inhibitors of the perchlorate respiratory pathway. This confirms the results observed in FIG. 3A-FIG. 3B. The IC₅₀s for the non-chloride halo-oxyanions against Azospira suillum PS grown on perchlorate are in the low millimolar range, between 1 and 3 mM.

Further, the IC₅₀ values against the growth of the sulfate reducing microorganism Desulfovibrio alaskensis G20 for the assayed oxyanions were also determined. It was observed that iodate, bromate and periodate are potent inhibitors of Desulfovibrio alaskensis G20; all three compounds have sub-millimolar IC₅₀s against this organism's growth (Table 2), demonstrating that these compounds are inhibitors of both perchlorate reduction and sulfate reduction. These compounds are also reactive with hydrogen sulfide.

### CONCLUSION

This Example demonstrates that the compounds bromate, periodate, and iodate, which are all halogenated analogs of (per)chlorate, are specific inhibitors of (per)chlorate respiration. Accordingly, these compounds may be used in a process for controlling the activity of DPRB in an environment by contacting the environment with one or more of these specific inhibitors of (per)chlorate respiration. These compounds have additional other beneficial properties, including that they can be readily generated by the electrochemical oxidation of bromide and iodide in seawater (Oh et al., 2010). Further, potassium bromate (KBrO₃) is a non-toxic compound.

### Example 2: Use of Inhibitors of (Per)Chlorate Respiration with (Per)Chlorate and DPRB to Control Reservoir Souring

This Example describes the injection of inhibitors of (per)chlorate respiration, such as bromate, iodate, or periodate, into an oil reservoir. The inhibitors of (per)chlorate respiration are added to the reservoir after the addition of perchlorate to the system. The perchlorate in the system acts to inhibit souring by stimulating the activity of DPRB in the system to oxidize sulfide compounds produced by SRM to elemental sulfur. After this oxidation is sufficiently complete, inhibitors of (per)chlorate respiration are added to the system to inhibit DPRB consumption of the (per)chlorate, thus allowing for the continued and enhanced inhibition of souring in the system.

An oil reservoir is selected that is suitable for secondary oil recovery procedures. This oil reservoir will be injected with perchlorate to decrease the hydrogen sulfide content and associated reservoir souring. Perchlorate is added to the reservoir such that the concentration of the perchlorate in the system is sufficient to inhibit souring in the reservoir. After a period of time following injection with perchlorate, a sample of reservoir fluid is taken and analyzed for hydrogen sulfide content. Sufficiently complete sulfide oxidation is generally the point when sulfide concentrations in the produced fluids are determined to be at an acceptable level. Measuring hydrogen sulfide levels is a standard chemical analysis and may be performed using, for example, Draeger tubes or online gas chromatographs.

Upon the determination that the perchlorate in the system has sufficiently allowed the DPRB in the system to oxidize the sulfide compounds produced by SRM, one or more of bromate, iodate, and periodate are added to the reservoir. These inhibitors of (per)chlorate respiration are added to the reservoir at a concentration sufficient to inhibit (per)chlorate respiration by DPRB in the reservoir.

After the inhibitors of (per)chlorate respiration are injected into the oil reservoir, the reservoir is monitored for signs of souring, microbial life, and/or evidence of sulfate-reducing metabolism. This method of injecting perchlorate into a reservoir followed by injecting an inhibitor of (per)chlorate respiration into the reservoir is evaluated in comparison to the development of souring in a comparable oil reservoir that is not injected with perchlorate and/or an inhibitor of (per)chlorate respiration by monitoring the growth of sulfate-reducing microorganisms, by monitoring the growth of DPRB, by monitoring the depletion of sulfate in the produced fluids, by monitoring an alteration of the stable isotopic fingerprint of sulfur and oxygen species in sulfate in the produced fluids, or by monitoring the production of sulfide in the reservoir.

Assays demonstrating the enhancement of the inhibition of souring by treatment with perchlorate followed by treatment with an inhibitor of (per)chlorate respiration can also be performed at lab scale using columns or other suitable means.

### Example 3: Use of Inhibitors of (Per)Chlorate Respiration to Control Reservoir Souring

This Example describes the injection of inhibitors of (per)chlorate respiration, such as bromate, iodate, or periodate, into an oil reservoir. The inhibitors of (per)chlorate respiration are added to the reservoir via injection waters. Once present in the system, these compounds may act to inhibit the activity of sulfate-reducing microorganisms and thus act to control souring in the system.

An oil reservoir is selected that is suitable for secondary oil recovery procedures. This oil reservoir will be injected with bromate, iodate, and/or periodate to inhibit sulfate-reducing activity of SRM and associated reservoir souring. The above compounds are added to the reservoir such that their concentration in the system is sufficient to inhibit souring in the reservoir. After a period of time following injection with these inhibitors, a sample of reservoir fluid is taken and analyzed for hydrogen sulfide content. Sufficiently complete sulfide oxidation is generally the point when sulfide concentrations in the produced fluids are determined to be at an acceptable level. Measuring hydrogen sulfide levels is a standard chemical analysis and may be performed using, for example, Draeger tubes or online gas chromatographs.

After the inhibitors of (per)chlorate respiration are injected into the oil reservoir, the reservoir is monitored for signs of souring, microbial life, and/or evidence of sulfate-reducing metabolism. This method of injecting bromate, iodate, and/or periodate into a reservoir is evaluated in comparison to the development of souring in a comparable oil reservoir that is not injected with one or more of these inhibitors by monitoring the growth of sulfate-reducing microorganisms, by monitoring the depletion of sulfate in the produced fluids, by monitoring an alteration of the stable isotopic fingerprint of sulfur and oxygen species in sulfate in the produced fluids, or by monitoring the production of sulfide in the reservoir.

Assays demonstrating the enhancement of the inhibition of souring by treatment with one or more of bromate, iodate, and/or periodate may be performed at lab scale using columns or other suitable means.

### REFERENCES

Gieg, L., Jack, T. & Foght, J. Biological souring and mitigation in oil reservoirs. Appl Microbiol Biotechnol 92, 263-282, doi: 10.1007/s00253-011-3542-6 (2011).
Youssef, N., Elshahed, M. S. & McInerney, M. J. Microbial processes in oil fields: culprits, problems, and opportunities. Advances in applied microbiology 66, 141-251 (2009).
Fuller, D. C. & Suruda, A. J. Occupationally related hydrogen sulfide deaths in the United States from 1984 to 1994. Journal of occupational and environmental medicine 42, 939-942 (2000).
Vance, I., Thrasher, D. R., Ollivier, B. & Magot, M. Petroleum Microbiology. (2005).
Hubert, C. in Handbook of Hydrocarbon and Lipid Microbiology (ed Kenneth N Timmis) Ch. 204, 2753-2766 (Springer Berlin Heidelberg, 2010).
Voordouw, G. et al. Sulfide Remediation by Pulsed Injection of Nitrate into a Low Temperature Canadian Heavy Oil Reservoir. Environmental Science & Technology 43, 9512-9518, doi:10.1021/es902211j (2009).
Lovley, D. R. & Chapelle, F. H. Deep subsurface microbial processes. Reviews of Geophysics 33, 365-381 (1995).
Rabus, R. & Heider, J. Initial reactions of anaerobic metabolism of alkylbenzenes in denitrifying and sulfate-reducing bacteria. Arch. Microbiol. 170, 377-384 (1998).
Lovley, D. R. & Goodwin, S. Hydrogen concentrations as an indicator of the predominant terminal electron accepting reactions in aquatic sediments. Geochim. Cosmochim. Acta. 52, 2993-3003 (1988).
Coates, J. D., Anderson, R. T., Woodward, J. C., Phillips, E. J. P. & Lovley, D. R. Anaerobic Hydrocarbon Degradation in Petroleum-Contaminated Harbor Sediments under Sulfate-Reducing and Artificially Imposed Iron-Reducing Conditions. Environmental Science & Technology 30, 2784-2789, doi:10.1021/es9600441 (1996).
Coates, J. D. et al. Anaerobic benzene oxidation coupled to nitrate reduction in pure culture by two strains of Dechloromonas. Nature 411, 1039-1043 (2001).
Lovley, D. R., Coates, J. D., Woodward, J. C. & Phillips, E. Benzene oxidation coupled to sulfate reduction. Appl Environ Microbiol 61, 953-958 (1995).
Christensen, T. H. et al. Characterization of redox conditions in groundwater contaminant plumes. Journal of Contaminant Hydrology 45, 165-241 (2000).
Callbeck, C. et al. Microbial community succession in a bioreactor modeling a souring low-temperature oil reservoir subjected to nitrate injection. Appl Microbiol Biotechnol 91, 799-810, doi: 10.1007/s00253-011-3287-2 (2011).
Callbeck, C. M., Agrawal, A. & Voordouw, G. Acetate production from oil under sulfate-reducing conditions in bioreactors injected with sulfate and nitrate. Applied and Environmental Microbiology 79, 5059-5068 (2013).
Greene, E., Hubert, C., Nemati, M., Jenneman, G. & Voordouw, G. Nitrite reductase activity of sulphate-reducing bacteria prevents their inhibition by nitrate-reducing, sulphide-oxidizing bacteria. Environmental Microbiology 5, 607-617 (2003).
Gevertz, D., Telang, A. J., Voordouw, G. & Jenneman, G. E. Isolation and Characterization of Strains CVO and FWKO B, Two Novel Nitrate-Reducing, Sulfide-Oxidizing Bacteria Isolated from Oil Field Brine. Applied and Environmental Microbiology 66, 2491-2501, doi: 10.1128/aem.66.6.2491-2501.2000 (2000).
Sunde, E., Torsvik, T., Ollivier, B. & Magot, M. Petroleum Microbiology. (2005).
Postgate, J. R. Competitive and Non-competitive Inhibitors of Bacterial Sulphate Reduction. Journal of General Microbiology 6, 128-142 (1952).
Baeuerle, P. A. & Huttner, W. B. Chlorate—a potent inhibitor of protein sulfation in intact cells. Biochemical and biophysical research communications 141, 870-877 (1986).
He, Q. et al. Impact of elevated nitrate on sulfate-reducing bacteria: a comparative Study of Desulfovibrio vulgaris. Isme J 4, 1386-1397, doi:http://www.nature.com/ismej/journal/v4/n 11/suppinfo/ismej201059s1.html (2010).
Gregoire, P. et al. Control of sulfidogenesis through bio-oxidation of H2S coupled to (per)chlorate reduction. Environmental Microbiology Reports (2014).
Bruce, R. A., Achenbach, L. A. & Coates, J. D. Reduction of (per)chlorate by a novel organism isolated from paper mill waste. Environmental microbiology 1, 319-329 (1999).
Coates, J. D. & Achenbach, L. A. Microbial perchlorate reduction: rocket-fuelled metabolism. Nat Rev Micro 2, 569-580 (2004).
Coates, J. D. et al. Ubiquity and diversity of dissimilatory (per) chlorate-reducing bacteria. Applied and Environmental Microbiology 65, 5234-5241 (1999).
Oh, B. S. et al. Formation of hazardous inorganic by-products during electrolysis of seawater as a disinfection process for desalination. The Science of the total environment 408, 5958-5965, doi:10.1016/j.scitotenv.2010.08.057 (2010).
Liebensteiner, M. G., Pinkse, M. W. H., Schaap, P. J., Stams, A. J. M. & Lomans, B. P. Archaeal (Per)Chlorate Reduction at High Temperature: An Interplay of Biotic and Abiotic Reactions. Science 340, 85-87 (2013).
Price M N, et al. (2013) Indirect and suboptimal control of gene expression is widespread in bacteria. Molecular systems biology 9:660.
Mukhopadhyay A, et al. (2006) Salt stress in Desulfovibrio vulgaris Hildenborough: an integrated genomics approach. Journal of bacteriology 188(11):4068-4078.
Bruce R A, Achenbach L A, & Coates J D (1999) Reduction of (per)chlorate by a novel organism isolated from paper mill waste. Environmental microbiology 1(4):319-329.

1. A method for controlling souring, the method comprising:
a) providing a system comprising one or more sulfate-reducing microorganisms and one or more (per)chlorate-reducing bacteria;
b) contacting the system with a composition comprising one or more chlorine oxyanions, or one or more precursor compounds which yield one or more chlorine oxyanions, wherein the chlorine oxyanions are present in the system at a concentration sufficient to inhibit souring in the system; and
c) contacting the system with a composition comprising an inhibitor of (per)chlorate respiration, wherein the inhibitor of (per)chlorate respiration is present in the system at a concentration sufficient to inhibit (per)chlorate respiration by the one or more (per)chlorate-reducing bacteria, wherein (per)chlorate consumption is reduced and souring is inhibited in the system.

2. The method of claim 1, wherein the system is an oil reservoir.

3. The method of claim 1, wherein the one or more (per)chlorate-reducing bacteria are selected from the group consisting of Ideonella; Dechloromarinus; Dechloromarinus strain NSS; Dechloromonas; Dechloromonas strain FL2, FL8, FL9, CKB, CL, NM, MLC33, JM, HZ, CL24plus, CL24, CC0, RCB, SIUL, and MissR; Dechloromonas aromaticae; Dechloromonas hortensis; Magnetospirillum; Magnetospirillum strain SN1, WD, DB, and VDY; Azospirillum; Azospirillum strain TTI; Azospira; Azospira strain AH, Iso1, Iso2, SDGM, PDX, KJ, GR-1, and perc lace; Azospira suillum strain PS; Acrobacter; Acrobacter strain CAB; Dechlorobacter; Dechlorobacter hydrogenophilus strain LT-1; Propionivibrio; Propionivibrio strain MP; Wolinella; Wolinella succinogenes strain HAP-1; Moorella; Moorella perchloratireducens, Moorella thermoacetica; Sporomusa; Sporomusa strain An4; Ferroglobus placidus; Desulfosporosinus meridiei; Desulfitobacterium dehalogenans; D. dechloroeliminans; Carboxydothermus hydrogenoformans; Proteus; Proteus mirabilis; Escherichia; Shewanella; Shewanella alga; Shewanella alga strain ACDC; Shewanella oneidensis strain MR1; Sedimenticola; Sedimenticola selenatireducens AK40H1; Sedimenticola selenatireducens CUZ; Rhodobacter; Rhodobacter capsulatus; Rhodobacter sphaeroides; Alicycliphilus; Alicycliphilus denitroficans; Pseudomonas strain PK, CFPBD, PDA, and PDB; Pseudomonas chloritidismutans; and Archaeglobus; Archaeglobus fulgidus.

4. The method of claim 1, wherein the one or more chlorine oxyanions are selected from the group consisting of hypochlorite, chlorine dioxide, chlorite, chlorate, perchlorate, and mixtures thereof.

5. The method of claim 4, wherein the one or more chlorine oxyanions are perchlorate.

6. The method of claim 1, wherein the method further comprises adding nitrite and/or nitrate at a concentration sufficient to inhibit souring in the system.

7. The method of claim 6, wherein the nitrite and/or nitrate is added to the system prior to adding the composition comprising one or more chlorine oxyanions to the system, or the one or more compounds which yield the one or more chlorine oxyanions.

8. The method of claim 6, wherein nitrite is added in an amount sufficient to yield a chlorine oxyanion to nitrite ratio of at least 100:1 in the system.

9. The method of claim 1, wherein the method further comprises a step of removing elemental sulfur produced by the one or more (per)chlorate-reducing bacteria from the system.

10. The method of claim 1, wherein the inhibitor of (per)chlorate respiration is a structural analog of (per)chlorate.

11. The method of claim 10, wherein the inhibitor of (per)chlorate respiration is selected from the group consisting of bromate, periodate, and iodate.

12. The method of claim 1, wherein the concentration of the inhibitor of (per)chlorate respiration in the system is in the range of about 0.05 mM to about 10 mM.

13. The method of claim 1, wherein souring in the system is inhibited by about 50% or more as compared to a corresponding system not contacted with one or more chlorine oxyanions and one or more inhibitors of (per)chlorate respiration.

14. The method of claim 13, wherein souring is assayed by measuring parameters selected from the group consisting of sulfate respiration, hydrogen sulfide production, fluid contamination, metal corrosion, and clogging of the system.

15. The method of claim 1, wherein the one or more (per)chlorate-reducing bacteria comprise one or more recombinant nucleic acids selected from the group consisting of a nucleic acid that encodes nar (Af_0174-0176); a nucleic acid that encodes pcrA (Daro_2584), a nucleic acid that encodes pcrB (Daro_2583), a nucleic acid that encodes pcrC (Daro_2582), a nucleic acid that encodes pcrD (Daro_2581), a nucleic acid that encodes cld (Daro_2580), a nucleic acid that encodes moaA (Daro_2577), a nucleic acid that encodes pcrQ (Daro_2579), a nucleic acid that encodes pcrO (Daro_2578), a nucleic acid that encodes pcrS (Daro_2586), a nucleic acid that encodes pcrR (Daro_2585), a nucleic acid that encodes pcrP (Daro_2587), a nucleic acid that encodes S (Daro_2590), a nucleic acid that encodes AS (Daro_2589), a nucleic acid that encodes OR1 (Daro_2591), a nucleic acid that encodes OR2 (Daro_2592), and a nucleic acid that encodes OR3 (Daro_2593).

16. The method of claim 1, wherein the one or more (per)chlorate-reducing bacteria comprise a cryptic (per)chlorate reduction pathway.

17. A method for controlling souring, the method comprising:
a) providing a system comprising one or more sulfate-reducing microorganisms;
b) contacting the system with one or more compounds selected from the group consisting of bromate, iodate, and periodate, wherein the one or more compounds are present in the system at a concentration sufficient to inhibit souring in the system.

18. The method of claim 17, wherein the system further comprises one or more (per)chlorate-reducing bacteria.

19. The method of claim 17, further comprising contacting the system with a composition comprising one or more chlorine oxyanions, or one or more precursor compounds which yield one or more chlorine oxyanions.

20. The method of claim 19, wherein the one or more chlorine oxyanions are selected from the group consisting of hypochlorite, chlorine dioxide, chlorite, chlorate, perchlorate, and mixtures thereof.

21. The method of claim 20, wherein the one or more chlorine oxyanions are perchlorate.

22. The method of claim 17, wherein the method further comprises adding nitrite and/or nitrate at a concentration sufficient to inhibit souring in the system.

23. The method of claim 22, wherein the nitrite and/or nitrate is added to the system prior to adding the composition comprising one or more chlorine oxyanions to the system, or the one or more compounds which yield the one or more chlorine oxyanions.

24. The method of claim 22, wherein nitrite is added in an amount sufficient to yield a chlorine oxyanion to nitrite ratio of at least 100:1 in the system.

25. The method of claim 18, wherein the method further comprises a step of removing elemental sulfur produced by the one or more (per)chlorate-reducing bacteria from the system.

26. The method of claim 17, wherein the concentration of one or more of bromate, iodate, and/or periodate in the system is in the range of about 0.05 mM to about 10 mM.

27. The method of claim 17, wherein souring in the system is inhibited by about 50% or more as compared to a corresponding system not contacted with one or more of bromate, iodate, and/or periodate.

28. The method of claim 27, wherein souring is assayed by measuring parameters selected from the group consisting of sulfate respiration, hydrogen sulfide production, fluid contamination, metal corrosion, and clogging of the system.

29. The method of claim 17, wherein the system is an engineered system.

30. A crude oil product produced by the method of claim 1.
